(19) United States
(12) Patent Application Publication
(10) Pub. No.: US 2010/0132053 A1
(43) Pub. Date: May 27, 2010

(54) INFORMATION PROCESSING DEVICE, INFORMATION PROCESSING METHOD AND PROGRAM

(75) Inventor: Hiroshi Chishima, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC CORPORATION, Tokyo (JP)

(21) Appl. No.: 12/089,326

(22) PCT Filed: Oct. 3, 2006
(86) PCT No.: PCT/JP2006/319799

§ 371 Date: Apr. 4, 2008

(30) Foreign Application Priority Data
Oct. 4, 2005 (JP) 2005-291190

(51) Int. Cl. G06F 21/22; G06F 9/30; G06F 9/54

(52) U.S. Cl. 726/30; 712/216; 719/328; 712/E09.028

(57) ABSTRACT

An illegal use of a privileged instruction and a library function by an application process is prevented. A concept of “security gate” is provided, and an instruction is located at a head of the library function in a high-reliability memory area which is not easy changed such as a ROM, to request a security gate entry to an OS. An instruction is located at the last of the library function to request a security gate exit to the OS. The security level is changed to a higher level and a privileged instruction is allowed to be executed, only when the application process in a security gate entry state.

### TECHNICAL FIELD

The present invention relates to an information processing apparatus in which whether or not a privileged instruction can be executed is controlled based on an attribute value group of an application process, when the application process executes the privileged instruction.

### BACKGROUND ART

In an information processing apparatuses, an operating system (OS) and a general application process are executed in a privileged level for the purpose of overhead reduction. Such an information processing apparatus is provided with a large number of library functions prepared by using privileged instructions.

On the other hand, in recent years, it is an important theme to secure security of the information processing apparatus. Following the aforementioned, a secure operating systems such as SE-Linux have been developed, in which a security level can be set for each application process. Here, the security level is one of attributes of an application process, which is an attribute used for judgment of access control of functions and resources used by the application process, exemplified by such attribute values as general user authority and root authority, and such attribute values as a reliable process (trusted) and a process with uncertain reliability (untrusted).

Under such an OS in which a security level is set for each application process, the library functions, which have been developed on the assumption that every application process is operated in the privileged level, cannot effectively used. This is because an error is generated as a privileged instruction violation when a library function called by an application process in a non-privileged level, contains an instruction in the privileged level. Needless to say, no problem arises for the use of library functions if every application process is set in the privileged level. However, there is no merit any more to use the secure operating system, in which the security level can be set for each application process.

For this reason, a technique was proposed that when an exception process is generated due to the execution of the privileged instruction during the execution of an application process in a user level, the privileged instruction is executed in the exception process and then a process flow returns from the exception process when an address of the privileged instruction is in a ROM area while an error is generated as a privileged instruction violation as a general rule when the address of the privileged instruction is in a RAM area. Thus, it is made possible to use the privileged instruction in the application process operating in the user level. Such a related art is disclosed in Japanese Patent Application Publication (JP-P2003-223317A), for example.

The following are other related arts. The invention of “privilege escalation based on preceding privileged level” disclosed in Japanese Patent Application Publication (JP-P2001-249848A) involves a computer system that includes a processor, a memory with a plurality of memory pages including a first memory page for storing a privilege escalation instruction, and an operating system, which is stored in the memory and controls the processor and the memory. The processor has a current privileged level for controlling execution of an application instruction in the computer system by controlling the possibility of access to system resources, and at the same time, has a preceding privileged level. The memory is a memory where it is impossible to perform a write operation into the first memory page by the application instruction at a first privileged level. The operating system executes the privilege escalation instruction through processing of reading out the preceding privileged level, comparing the read preceding privileged level and the current privileged level, and escalating the current privileged level to a second privileged level, which is higher than the first privileged level, when a privilege level that is equal to or below the current privilege level is given to the preceding privileged level.

In “system call execution device” disclosed in Japanese Patent 2,677,458, a first section for performing system call processing involves a task that includes a privileged task for performing system management and a user task. When transition is made from user task processing to privileged task processing, it is possible to perform saving of the CPU mode (operation result flag), an instruction pointer, and a memory area or a register area, which are used by the privileged task, or shift control to the privileged task without performing the data backup at all. In addition, at the time of issuing a system call on the user task, the system call issuing executes a system call instruction that includes a system call opecode and a value of an address table in which a start address of an execution instruction of a privileged bank is stored. A second section for performing branch processing involves a branch instruction which at the time of execution of the branch instruction on the user task, specifies a branch instruction opecode and an address table in which the start address of the execution instruction of the privileged bank is stored. Consequently, the branch instruction is executed which includes double indirect addresses with which the start address of the instruction can indirectly be specified. When executing interrupt, a third section for performing interrupt processing performs interrupt processing based on an address table in which interrupt processing start addresses are stored that are specified for every interrupt processing factor. At the time of the execution by any one of the three sections, it is determined based on an address of the address table itself, whether to perform shift to the privileged task and backup processing. At the same time, a section is provided for switching the CPU to a privilege mode without software intervention, when transition is made from the user task processing to the privileged task processing.

In the invention of “information processing apparatus” disclosed in Japanese Patent Application Publication (JP-A-Heisei 5-100957), a program execution level register stores a plurality of execution levels showing a privilege degree of a program to be executed. A memory section has a plurality of memory areas to which a plurality of access execution levels are respectively specified. A memory access execution level register stores execution levels corresponding to the access execution levels of the memory areas of the memory section. A comparator compares an execution level of a program being currently executed from the program execution level register and an access execution level of a memory area of the memory section specified by the program from the memory access execution level register. When the execution level and the access execution level match, the comparator outputs a match signal. An instruction sequencer allows the program being currently executed to access a memory area of the memory section specified by the program, in response to the match signal.

“Information processing device and access level controlling method” disclosed in Japanese Patent Application Publication (JP-P2002-342166A) involves an information processing apparatus in which access levels can be changed for every process. An access detection section detects an access to a given address from the processing section. An access section can change an access levels when the access to the given address is detected by the access detection section.

### DISCLOSURE OF INVENTION

According to Japanese Patent Application Publication (JP-P2003-223317A) mentioned above, it possible to provide the application process with a function of a library function if the library function that includes a privileged instruction is held in the ROM area, in order to allow an application process operating at the user level to execute the privileged instruction located in the ROM area, which is a memory area that alteration is difficult. On the other hand, it possible to prevent an illegal use of a privileged instruction in an application code since execution of the privileged instruction located in a RAM area, which is a memory area that alteration is easy, by the application process operating at the user level can be prohibited.

However, there is no resistance to an attack that an application process jumps directly to a privileged instruction in a library function located in the ROM area. The reason is that, although exception processing is generated due to the execution of the privileged instruction at the jump destination, the privileged instruction is executed as the exception processing since the address of the privileged instruction is in the ROM area. Since a library function is originally created on the assumption that basically the entire processing from an entrance to an exit is performed, an improper attack to perform only part of the processing will cause an unexpected situation.

The present invention is proposed in view of the above circumstances, and an object of the present invention is to prevent an illegal use of a privileged instruction by an application process.

Another object of the present invention is to prevent an illegal use of a library function by an application process.

An information processing apparatus of the present invention includes a storage section configured to store an application process, an attribute value group thereof, a library function, and an permissible address range of the first specific instruction, wherein in the library function, a first specific instruction is executed before execution of a portion for guaranteeing execution of processing performed in the library function, and a second specific instruction is executed before returning to a calling source of a call; a privileged instruction execution controlling section configured to determine and control whether execution of a privileged instruction is permissible or not, based on the attribute value of the application process when internal interrupt is generated after the application process executes the privileged instruction; a security gate entering section configured to check whether an address of the first specific instruction is in the permissible address range when the internal interrupt is generated after the application process executes the first specific instruction, and to change the attribute value group of the application process if the address of the first specific instruction is in the permissible address range; and a security gate exiting section configured to restore the attribute value of the application process when the application process executes the second specific instruction and the internal interrupt is generated.

In the information processing apparatus according to the present invention, the attribute value group indicates a security level of the application process.

In the information processing apparatus according to the present invention, the privileged instruction execution controlling section performs an authority check by using the security level of the application process, and executes the privileged instruction when authority is granted to execute the privileged instruction.

In the information processing apparatus according to the present invention, the attribute value group indicates a security gate entry state of the application process.

In the information processing apparatus according to the present invention, the privileged instruction execution controlling section executes the privileged instruction when the application process is in the security gate entry state.

In the information processing apparatus according to the present invention, the attribute value group includes an attribute value indicating the security level of the application process and an attribute value indicating the security gate entry state of the application process.

In the information processing apparatus according to the present invention, the privileged instruction execution controlling section omits the authority check based on the security level of the application process when the application process is in the security gate entry state, and executes the privileged instruction, and performs the authority check based on the security level of the application process when the application process is not in the security gate entry state and executes the privileged instruction when the authority to execute the privileged instruction is granted.

In the information processing apparatus according to the present invention, the security gate entering section changes the security level of the application process in the security gate entry state,

the security gate exiting section restores the security level of the application process in the security gate exit state, and

the privileged instruction execution controlling section performs the authority check based on the security level of the application process and executes the privileged instruction when the authority to execute the privileged instruction is granted.

In the information processing apparatus according to the present invention, the privileged instruction execution controlling section performs the authority check based on the security level of the application process after updating the security level of the application process when the application process is in the security gate entry state, and restores the security level back to an original level after executing the privileged instruction when the authority to execute the privileged instruction is granted.

The information processing apparatus according to any of the present invention, further includes a security gate temporary exiting section configured to change the security level of the application process to an original level before the security gate entry state, before calling a signal/interrupt handler of the application process, when a signal or interrupt is generated during running of the application process in the security gate entry state, and restoring the security level after the security gate entry state when or after processing by the signal/interrupt handler ends.

The information processing apparatus according to the present invention further includes a security gate temporary exiting section configured to restore the attribute value group of the application process back to the attribute value group before change by the security gate entering section, before calling signal/interrupt handler of the application process, when a signal or interrupt is generated during running of the application process until the attribute value group of the application process is restored by the security gate exiting section, after the attribute value group of the application process is changed by the security gate entering section, and to restore the attribute value group after the change by the security gate entering section when or after processing by the signal/interrupt handler ends.

In the information processing apparatus according to the present invention, the security gate entering section changes the security level of the application process to a privileged level.

The information processing apparatus according to the present invention further includes a security level change policy database configured to store a security level changing rule, wherein the security gate entering section changes the security level of the application process based on the security level changing rule.

In an information processing apparatus according to the present invention, the attribute value group indicating the security gate entry state of the application process is recorded as one flag of the process management database which stores one security level corresponding to a process ID of each application process at least.

The information processing apparatus according to the present invention further includes a database configured to manage a list of application processes in the security gate entry state, and the attribute value group indicating the security gate entry state of the application process is determined based on whether or not the process ID is recorded in the database.

In the information processing apparatus according to the present invention, the library function includes the first specific instruction located before processing description for guaranteeing execution and the second specific instruction located before an exit returning to the calling source.

In the information processing apparatus according to the present invention, the library function includes the first specific instruction located before processing description for guaranteeing execution, and an instruction sequence located on a processing control that is necessarily executed after the first specific instruction, to change a stack of the application process so as to go through a function including the second specific instruction, before returning to the calling source.

In the information processing apparatus according to the present invention, the library function has the first specific instruction located before processing description for guaranteeing execution, and

the security gate entering section changes a stack of the application process such that the application process goes through a function that includes the second specific instruction, before returning to the calling source, when the attribute value group of the application process is changed.

In the information processing apparatus according to the present invention, a predetermined address range is within a ROM area.

In the information processing apparatus according to the present invention, a predetermined address range is an address range on a RAM area of the library function loaded from a ROM area into the RAM area.

In the information processing apparatus according to the present invention, a predetermined address range is an address range on a RAM area of the library function loaded from a reliable file system into the RAM area.

In the information processing apparatus according to the present invention, a predetermined address is an address range on a RAM area of a reliable library function loaded from a file system into the RAM area.

In the information processing apparatus according to the present invention, when internal interrupt is generated after the application process executes the first specific instruction, the security gate entering section performs a check of whether or not the address of the first specific instruction is in a program area in addition to a check of whether or not the address of the first specific instruction is within the permissible address range.

In the information processing apparatus according to the present invention, the first specific instruction and the second specific instruction are system call instructions for issuing security gate entry request and exit request to an operating system, respectively.

In the information processing apparatus according to the present invention, the library function includes a basic library function and a service API library function.

In the information processing apparatus according to the present invention, the basic library function includes a shared memory operation system call instruction and a semaphore operation system call instruction as the privileged instructions, and

the service API library function includes a program code which uses the basic library function including the shared memory operation system call instruction and the semaphore operation system call instruction.

In the information processing apparatus according to the present invention, the basic library function includes a socket communication system call instruction as the privileged instruction in order to establish communication with an X server, and

the service API library function includes a program code which uses the basic library function including the socket communication system call instruction.

In the information processing apparatus according to the present invention, the basic library function includes a file open system call instruction as the privileged instruction in order to open a file that includes target content of DRM management, and

the service API library function performs DRM processing and includes a program code that uses the basic library function, which includes the file open system call instruction.

In the information processing apparatus according to the present invention, wherein the basic library function includes a socket communication system call instruction as the privileged instruction in order to establish communication with an outside server, and

the service API library function performs HTTP processing and includes a program code that uses the basic library function, which includes the socket communication system call instruction.

An information processing method includes retaining, in an information processing apparatus, an application process, an attribute value group thereof, an permissible address range of a first specific instruction, and a library function, in which the first specific instruction is executed before execution of a portion for guaranteeing execution of processing performed in the library function and a second specific instruction is executed before returning to a calling source of call; performing a privileged instruction execution controlling process to control execution of a privileged instruction based on the attribute value group of the application process when internal interrupt is generated after the application process executes the privileged instruction; performing a security gate entering process to check whether or not an address of the first specific instruction is within the permissible address range, when the internal interrupt is generated after the application process executes the first specific instruction, and changing the attribute value group of the application process when the address of the first specific instruction is within the permissible address range; and performing a security gate exiting process to restore the attribute value group of the application process when the internal interrupt is generated after the application process executes the second specific instruction.

In the information processing method according to the present invention, the attribute value group indicates a security level of the application process.

In the information processing method according to the present invention, the performing a privileged instruction execution controlling process includes:

performing an authority check based on the security level of the application process; and

executing the privileged instruction when authority to execute the privileged instruction is granted.

In the information processing method according to the present invention, the attribute value group indicates a security gate entry state of the application process.

In the information processing method according to the present invention, the performing a privileged instruction execution controlling process includes:

executing the privileged instruction when the application process is in the security gate entry state.

In the information processing method according to the present invention, the attribute value group includes an attribute value indicates a security level of the application process and an attribute value indicating a security gate entry state of the application process.

In the information processing method according to the present invention, the performing a privileged instruction execution controlling process includes:

executing a privileged instruction without authority check based on a security level of the application process when the application process is in a security gate entry state;

performing authority check based on the security level of the application process when the application process is not in the security gate entry state; and

executing the privileged instruction when the authority to execute a privileged instruction is granted.

In the information processing method according to the present invention, the performing a security gate entering process includes:

changing a security level of the application process that is in a security gate entry state,

the performing a security gate exiting process includes:

restoring a security level of the application process that is in the security gate exit state, and

the performing a privileged instruction execution controlling process includes:

checking the authority check based on the security level of the application process; and

executing the privileged instruction when authority to execute the privileged instruction is granted.

In the information processing method according to the present invention, the performing a privileged instruction execution controlling process includes:

performing authority check based on the security level of the application process after the security level of the application process is updated when the application process is in the security gate entry state; and

restoring the security level to an original level after the privileged instruction is executed when the authority to execute the privileged instruction is granted.

In the information processing method according to the present invention, the information processing apparatus restores the security level of the application process back to a level before the security gate entry state, before calling a signal/interrupt handler of the application process when a signal or interrupt is generated during running of the application process in the security gate entry state; and performs a security gate temporary exiting process in which the security level is restored to a level after the security gate entry state when or after processing by the signal/interrupt handler ends.

In the information processing method according to the present invention, the information processing apparatus restores the attribute value group of the application process to the attribute value group before change by the security gate entering process, before calling a signal/interrupt handler of the application process when a signal or interrupt is generated during running of the application process until the attribute value group of the application process is restored by the security gate exiting process after the attribute value group of the application process is changed by the security gate entering process; and performs a security gate temporary exiting process to restore the attribute value group to the attribute value group after the change by the security gate entering process when or after processing by the signal/interrupt handler is ends.

In the information processing method according to the present inventions, the performing a security gate entering process includes:

changing the security level of the application process to a privileged level.

In the information processing method according to the present inventions, a computer includes a security level change policy database to hold a security level changing rule, and

the performing a security gate entering process includes:

changing the security level of the application process based on the security level changing rule.

In the information processing method according to the present inventions, the attribute value group indicating the security gate entry state of the application process is recorded as one flag of a process management database to hold the security level corresponding to a process ID of each application process.

In the information processing method according to the present inventions, the information processing apparatus includes a database for managing a list of application processes in a security gate entry state, and

the attribute value group indicating a security gate entry state of the application process is determined depending on whether or not a process ID is recorded in the database.

In the information processing method according to the present inventions, wherein the library function includes the first specific instruction located before processing description for guaranteeing execution, and the second specific instruction is located before an exit returning to the calling source.

In the information processing method according to the present invention, the library function includes the first specific instruction located before processing description for guaranteeing execution and an instruction sequence for changing a stack of the application process such that a function that includes the second specific instruction, is gone through on a path to be necessarily executed after a location where the first specific instruction is located, before returning to the calling source.

In the information processing method according to the present invention, the library function includes the first specific instruction located before processing description for guaranteeing execution, and

the performing a security gate entering process includes:

changing the stack of the application process such that the application process goes through a function that includes the second specific instruction, before returning to the calling source, when the attribute value group of the application process is changed.

### [Operation]

In the present invention, when an application process calls a library function, a first specific instruction is executed before execution of a portion for guaranteeing execution of processing performed in the library function, and internal interrupt is generated. In exception processing relevant to the internal interrupt, a security gate entering section checks whether or not an address of the first specific instruction is within an permissible address range, and an attribute value group of the application process is changed so that a privileged instruction can be executed when the address is within the permissible address range, while such change of the attribute value group is not carried out when the address is not within the permissible address range. After that, succeeding processing of the called library function is performed, and the portion for guaranteeing execution is executed. When the library function processing proceeds to a point of a privileged instruction, an internal interrupt is generated through execution of the privileged instruction, and a privileged instruction execution controlling section controls execution of the privileged instruction based on the attribute value group of the application process in the exception processing relevant to the internal interrupt. Therefore, the first specific instruction is not executed so that the attribute value group remains in a state that the privileged instruction cannot be executed when the application, process that is not allowed to execute the privileged instruction jumps directly to the privileged instruction. On the other hand, it is possible to execute the privileged instruction since the attribute value group is changed through the execution of the first specific instruction so that the privileged instruction can be used when the first specific instruction normally calls a library function present within a permissible address range. In this case, the portion for guaranteeing execution, located after the first specific instruction is executed necessarily. When the application process executes a second specific instruction before returning from the library function to the application process, which is a calling source of the call, an internal interrupt is generated, and the attribute value group of the application process is restored to an original state that the privileged instruction cannot be executed, by a security gate exiting section in the exception processing relevant to the internal interrupt. As a result, execution of the privileged instructions other than privileged instructions included in the library function is prevented.

According to the present invention, it is possible to provide the application process with the library function that includes the privileged instruction whose execution is not allowed based on the attribute value group set to the application process. This is because, as for a normal library function provided to the application process, an address of the first specific instruction is checked to determine whether to be in the permissible address range at the time of the execution of the first specific instruction and the attribute value group of the application process is changed to make it possible to execute the privileged instruction, when the application process calls the library function, by setting the address range where the first specific instruction included in the library function is present, as the permissible address range.

According to the present invention, it is possible to prevent an illegal use of the library function, in which the portion for guaranteeing execution is passed and a remaining part including the privileged instruction is executed. This is because, when the application process performs an improper operation to pass the portion for guaranteeing execution of the processing in the library function and jumps directly to another point, the first specific instruction is not executed and the attribute value group is not changed, causing an error at the time of executing the privileged instruction.

According to the present invention, it is possible to prevent an illegal use of the privileged instruction by the application process. This is because a state that the privileged instruction can be executed is limited to only execution of the library function, since an original attribute value is restored by the second specific instruction before returning from the library function to the application process.

### BRIEF DESCRIPTION OF DRAWINGS

FIG. 1 is a block diagram showing an example of a hardware configuration of an information processing apparatus of the present invention;

FIG. 2 is a block diagram of a first exemplary embodiment of the present invention;

FIG. 3 is a block diagram of a second exemplary embodiment of the present invention;

FIG. 4 is a block diagram of a modification example of the second exemplary embodiment of the present invention;

FIG. 5 is a block diagram of a third exemplary embodiment of the present invention;

FIG. 6 is a block diagram of an example 1 of the first exemplary embodiment of the present invention;

FIG. 7 is a flow diagram showing operation of the example 1 of the first exemplary embodiment of the present invention;

FIG. 8 is a flow diagram showing the operation of the example 1 of the first exemplary embodiment of the present invention;

FIG. 9 is a flow diagram showing the operation of the example 1 of the first exemplary embodiment of the present invention;

FIG. 10 shows contents examples of an application program, an API library program, and a basic library program in the example 1 of the first exemplary embodiment of the present invention;

FIG. 11 is a block diagram showing a specific application example 1 in the example 1 of the first exemplary embodiment of the present invention;

FIG. 12 is a block diagram showing a specific application example 2 in the example 1 of the first exemplary embodiment of the present invention;

FIG. 13 is a block diagram showing a specific application example 3 in the example 1 of the first exemplary embodiment of the present invention;

FIG. 14 is a block diagram showing a specific application example 4 in the example 1 of the first exemplary embodiment of the present invention;

FIG. 15 is a block diagram of an example 2 of the first exemplary embodiment of the present invention;

FIG. 16 is a flow diagram showing an operation of the example 2 of the first exemplary embodiment of the present invention;

FIG. 17 is a flow diagram showing an operation of the example 2 of the first exemplary embodiment of the present invention;

FIG. 18 is a flow diagram showing an operation of the example 2 of the first exemplary embodiment of the present invention;

FIG. 19 is a block diagram of a modification example of the example 2 of the first exemplary embodiment of the present invention;

FIG. 20 is a block diagram of an example 3 of the first exemplary embodiment of the present invention;

FIG. 21 is a flow diagram showing an operation of the example 3 of the first exemplary embodiment of the present invention;

FIG. 22 is a block diagram of an example 4 of the first exemplary embodiment of the present invention;

FIG. 23 is a flow diagram showing operation of the example 4 of the first exemplary embodiment of the present invention;

FIG. 24 is a block diagram of an example 1 of the second exemplary embodiment of the present invention;

FIG. 25 is a diagram for describing stack modification processing in an example 1 of the second exemplary embodiment of the present invention;

FIG. 26 is a block diagram of an example 1 of the third exemplary embodiment of the present invention; and

FIG. 27 is a flow diagram showing an operation of the example 1 of the third exemplary embodiment of the present invention.

### BEST MODE FOR CARRYING OUT THE INVENTION

Hereinafter, an information processing apparatus according to the exemplary embodiments of the present invention will be described in detail with reference to the attached drawings.

### <Example of Hardware Configuration of Information Processing Apparatus in the Invention>

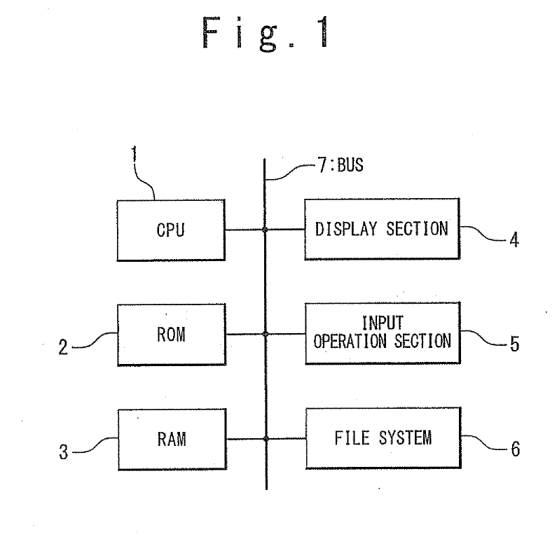

With reference to FIG. 1, an example of a hardware configuration of the information processing apparatus according to the present invention includes a CPU 1, a ROM 2, a RAM 3, a display section 4, an input operation section 5, a file system 6, and a bus 7 for connecting these sections with each other. The ROM 2 is a read-only memory, and stores an operating system (OS) executed on the CPU 1, a library function, fixed data, and so forth. The RAM 3 is a readable and writable memory, and temporarily stores an application process executed in the CPU 1, operation data, and so forth. The display section 4 includes an LCD, and displays an application screen and so forth. The input operation section 5 includes a keyboard, and inputs data and instructions from a user. The file system 6 includes a hard disk and an SD card, and stores an application program and various types of data. Examples of the information processing apparatus having such a hardware configuration are a general computer such as a personal computer, a gate terminal, and a cellular telephone.

### First Exemplary Embodiment

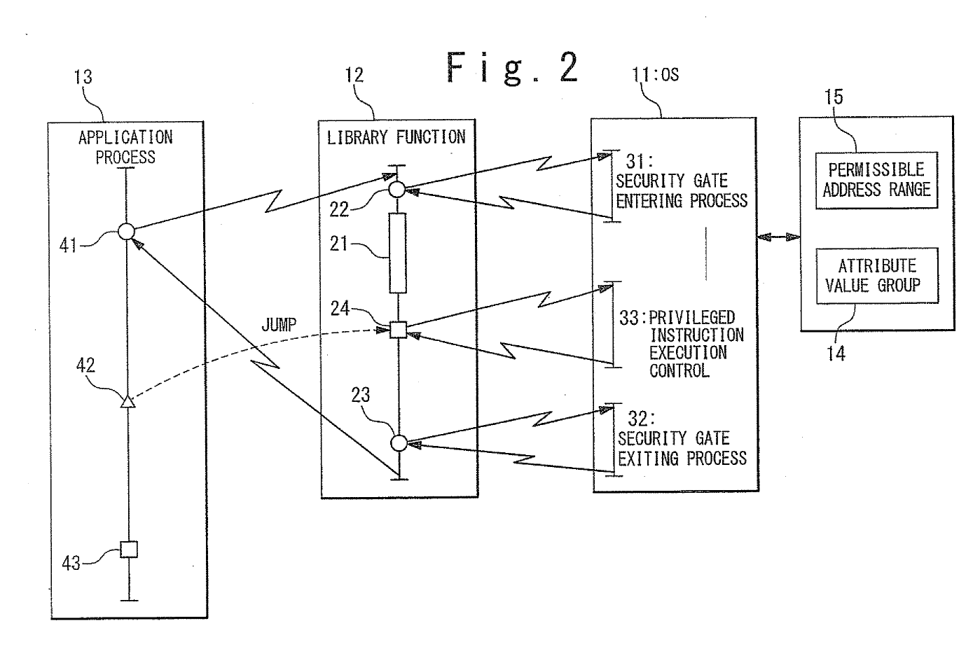

In the first exemplary embodiment of the present invention, with reference to FIG. 2, an operating system (OS) 11, a library function 12, an application process 13, an attribute value group 14, and a permissible address range 15 of a first specific instruction are retained in a computer-readable recording medium.

In the library function 12, the first specific instruction 22 is executed before execution of a part 21 for guaranteeing execution of processing performed in the function itself, and a second specific instruction 23 is executed before returning to a calling source of call. Typically, the first specific instruction 22 is located at the head position of the function and the second specific instruction 23 is located at a position immediately before returning step to the calling source. The library function 12 includes one privileged instruction 24 or more. The first specific instruction 22, the second specific instruction 23, and the privileged instruction 24 are system calling instructions. When internal interrupt is generated at the time of the execution thereof, the control is shifted to the OS 11. Also, the permissible address range 15 of the first specific instruction 22 is set in advance, and is referred to by the OS 11 at the time of the generation of internal interrupt through the execution of the first specific instruction 22.

The application process 13 executes a call instruction 41 for calling the library function 12, a jump instruction 42 which the control jumps directly to the privileged instruction 24 in the library function 12, and a privileged instruction 43.

The OS 11 is a secure operating system in which a security level can be set for each application process 13. The OS 11 manages the attribute value group 14 of each application process 13. The attribute value group 14 includes at least one attribute value used for judgment of access control of functions and resources which the application process 13 uses. Specific examples of the attribute values 14 are an attribute value to indicate the security level, and an attribute value to indicate a security gate entering state. Also, a system has functions of performing a security gate entering process 31, a security gate exiting process 32, and privileged instruction execution control 33 as exception processes corresponding to internal interrupts generated through the execution of the first specific instruction 22, the second specific instruction 23, and the privileged instructions 24 and 43.

In the privileged instruction execution control 33, the execution of the privileged instructions 24 and 43 is controlled based on the attribute value group 14 of the application process 13, when the application process 13 calls the library function 12 and executes the privileged instruction 24 and when the privileged instruction 43 on application codes is executed.

In the security gate entering process 31, it is checked whether or not an address of the first specific instruction 22 is within the permissible address range 15, when the application process 13 executes the first specific instruction 22, and the attribute value group 14 of the application process 13 is changed if the address of the first specific instruction 22 is within the permissible address range 15.

In the security gate exiting process 32, the attribute value group 14 of the application process 13 is returned to an original value group, when the application process 13 executes the second specific instruction 23.

Next, an operation of the information processing apparatus of the first exemplary embodiment will be described. Here, it is assumed that the attribute value group 14 of the application process 13 is set to a value group by which a privileged instruction cannot be executed. It is assumed that a memory address range of a memory where a normal library function 12 is located (e.g. the ROM 2 in FIG. 1) is set as the permissible address range 15.

When the application process 13 calls the library function 12 through a call instruction 41, the first specific instruction 22 located at the head position of the library function 12 is firstly executed, and then the attribute value group 14 of the application process 13 is changed by the security gate entering process 31 of the OS 11. For instance, the security level is changed when the execution of the privileged instruction is controlled in the security level, and an attribute value to indicate a security gate entering state is changed when the execution of the privileged instruction is controlled based on a security gate entering state. It should be noted that it is possible to perform processing that the attribute value to indicate the security gate entering state is first changed at this time. Thereafter, determination of the security gate entering state is made at the time of the privileged instruction execution control 33, and when it is determined to be in a security gate entering state, the security level and subsequently the execution of the privileged instruction is determined and controlled based on the security level and then the security level is restored.

Next, when the privileged instruction 24 is executed by the application process 13 after a portion 21 for guaranteeing execution of the processing in the library function is executed, the execution of a privileged instruction is determined and controlled by the privileged instruction execution control 33 of the OS 11 based on the attribute value group 14 of the application process 13, and the privileged instruction 24 is executed when the execution is permitted, and then the control is returned to a calling source of a call.

Next, when the process of the library function 12 proceeds and the second specific instruction 23 is executed immediately before returning to the calling source, the attribute value group 14 of the application process 13 is returned to a state before security gate entry by the security gate exiting process 32 of the OS 11.

After that, when the application process 13 executes the instruction 42 which jumps directly to the privileged instruction 24 of the library function 12, which is the jump destination, the control is shifted to the privileged instruction execution control 33 of the OS 11 as a result of the execution of the privileged instruction 24. However, since the first specific instruction is not executed so that the attribute value group 14 of the application process 13 is also not changed to execute a privileged instruction, the privileged instruction is not executed and an error is generated in the privileged instruction execution control 33.

In addition, the control is shifted to the privileged instruction execution control 33 of the OS 11 when the application process 13 directly executes the privileged instruction 43. However, in this case, too, the privileged instruction is not executed and an error is generated in the privileged instruction execution control 33 since the first specific instruction is not executed so that the attribute value group 14 of the application process 13 is also not changed to execute the privileged instruction.

According to the present exemplary embodiment as mentioned above, it is possible to prevent unauthorized use of the privileged instructions 24 and 43 and the library function 12 by the application process 13.

### Second Exemplary Embodiment

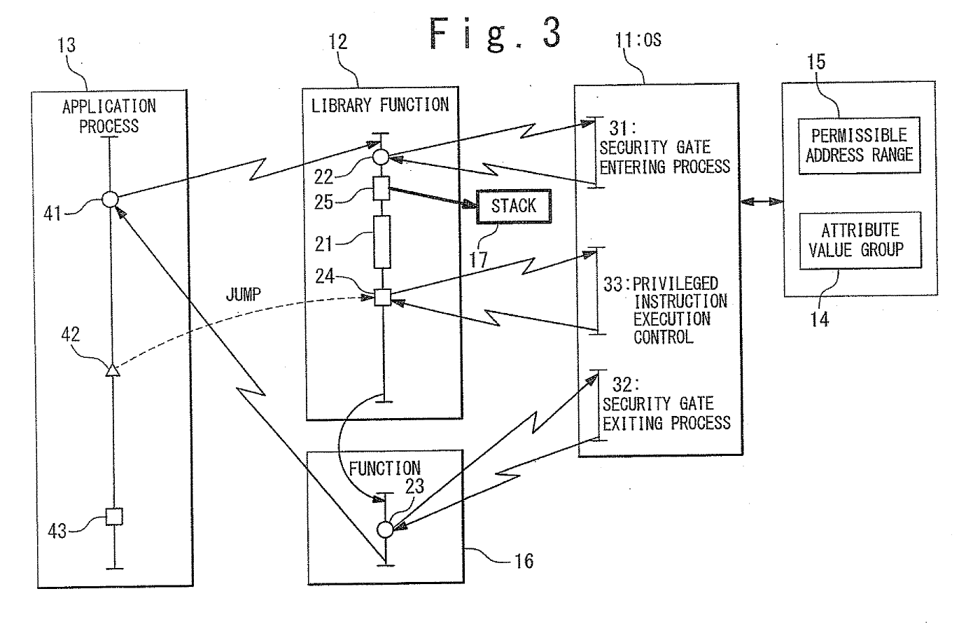

With reference to FIG. 3, the second exemplary embodiment of the present invention is different from the first exemplary embodiment in that the second specific instruction 23 is not located in the library function 12 and, instead, an instruction sequence 25 is located to modify (update) a stack 17 of the application process 13 such that a function 16 that includes the second specific instruction 23 is executed before returning to a calling source of call. Here, the location of the instruction sequence 25 may be optional if the instruction sequence 25 is on a path that it is necessarily executed without fail after the first specific instruction 22.

Next, an operation of the second exemplary embodiment will be described mainly on the difference from the first exemplary embodiment.

When the application process 13 calls the library function 12 through the call instruction 41, the first specific instruction 22 located at the head position of the library function 12 is firstly executed, and the attribute value group 14 of the application process 13 is changed by the security gate entering process 31 of the OS 11. Subsequently, as a result of execution of the instruction sequence 25 by the application process 13, the stack 17 is modified such that the function 16 is executed before returning to the application process 13. Next, when the privileged instruction 24 is executed by the application process 13 after the portion 21 for guaranteeing execution is executed, the execution of a privileged instruction is judged by the privileged instruction execution control 33 of the OS 11 based on the attribute value group 14 of the application process 13, and the privileged instruction 24 is executed when the execution is permitted. Then, the control is returned to the calling source. Next, the process of the library function 12 proceeds and information of the function 16 can be obtained by popping the stack 17 in order to obtain information of the calling source. Thus, the function 16 is called and the second specific instruction 23 in the function 16 is executed. As a result, the security gate exiting process 32 of the OS 11 is executed and the attribute value group 14 of the application process 13 is returned to the state before security gate entry.

The operations in case that the application process 13 executes the instruction 42 which jumps directly to the privileged instruction 24 of the library function 12 and the application process 13 executes the privileged instruction 43 are the same as those of the first exemplary embodiment.

According to the second exemplary embodiment as mentioned above, it is possible to prevent unauthorized use of the privileged instructions 24 and 43 and the library function 12 by the application process 13. When there are a plurality of exits to return from the library function 12 to the application process 13 as the calling source, the second exemplary embodiment is advantageous in that it is sufficient to locate only a single instruction sequence 25, while the second specific instruction needs to be located before every exit in a method of locating the second specific instruction in the library function 12.

### Modification of Second Exemplary Embodiment

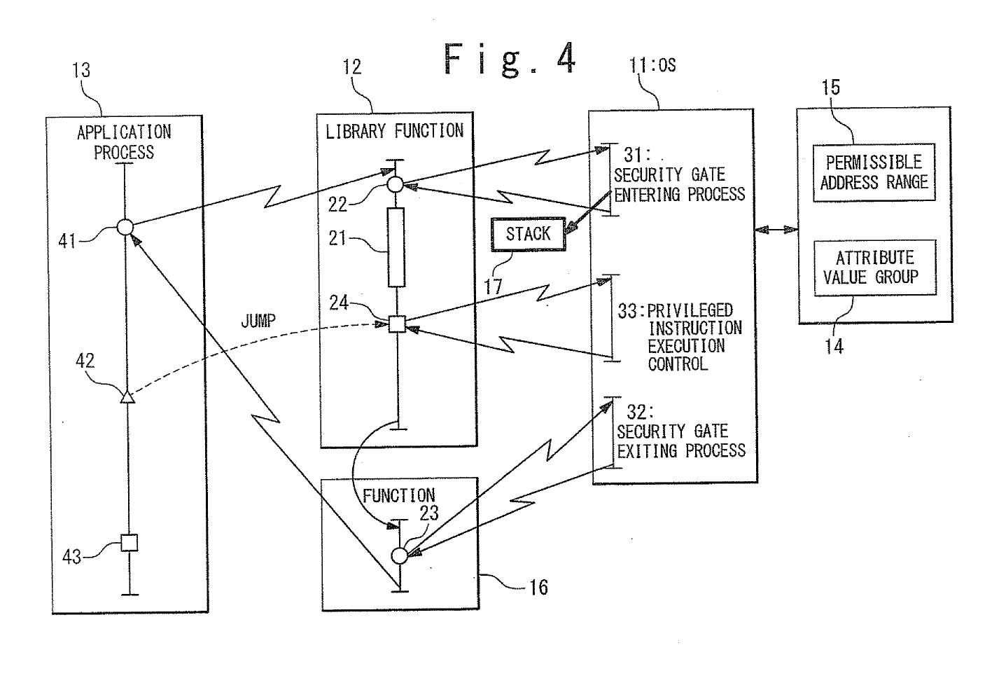

With reference to FIG. 4, the information processing apparatus according to a modification example of the second exemplary embodiment of the present invention is different from the first exemplary embodiment in that the second specific instruction 23 is not located in the library function 12 and a process is added to modify (update) the stack 17 in the security gate entering process 31 of the OS 11 such that the function 16 containing the second specific instruction 23 is gone through when the processing control returns from the library function 12 to the application process 13.

Next, an operation of the present exemplary embodiment will be described mainly in the difference from the first exemplary embodiment.

When the application process 13 calls the library function 12 by the call instruction 41, the first specific instruction 22 located at the head position of the library function 12 is firstly executed, and the attribute value group 14 of the application process 13 is changed and the stack 17 is modified such that the processing control returns from the library function 12 to the application process 13 through the function 16, through the security gate entering process 31 of the OS 11. Next, when the privileged instruction 24 is executed by the application process 13 after a portion 21 for guaranteeing execution of processing is executed, the execution of the privileged instruction is judged by the privileged instruction execution control 33 of the OS 11 based on the attribute value group 14 of the application process 13. The privileged instruction 24 is executed when the execution is permitted or possible, and the processing control returns to the calling source. Next, the processing of the library function 12 proceeds and the function 16 is called, where data of the function 16 can be obtained by popping the stack 17 in order to obtain information of the calling source, the second specific instruction 23 in the function 16 is executed. As a result, the security gate exiting process 32 of the OS 11 is executed and the attribute value group 14 of the application process 13 is returned to the state before the security gate entry.

The operations when the application process 13 executes the instruction 42 by which the processing control directly jumps to the privileged instruction 24 of the library function 12, and when the application process 13 executes the privileged instruction 43 are the same as those in the first exemplary embodiment.

According to the present exemplary embodiment as mentioned above, it is possible to prevent unauthorized use of the privileged instructions 24 and 43 and the library function 12 by the application process 13. Additionally, when there are a plurality of exits returning from the library function 12 to the application process 13 as the calling source, it is necessary to locate the second specific instruction before every exit when the method of locating the second specific instruction in the library function 12 is employed. Thus, in the second exemplary embodiment, one instruction sequence 25 needs to be located. However, these instructions are all unnecessary in the present exemplary embodiment.

### Third Exemplary Embodiment

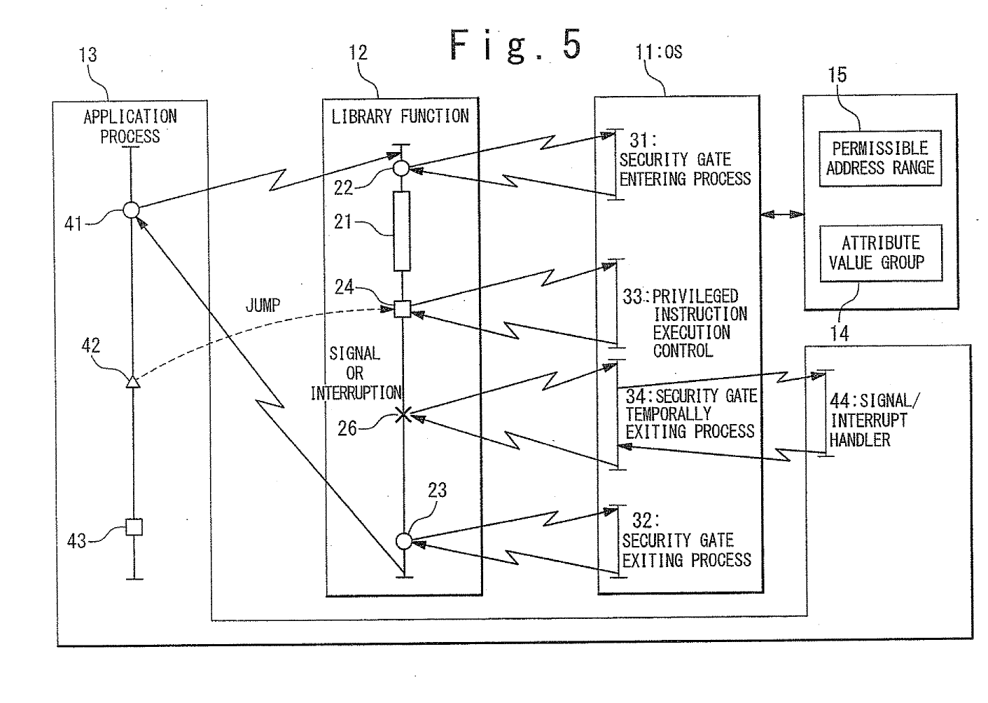

With reference to FIG. 5, the third exemplary embodiment of the present invention is different from the first exemplary embodiment in that a security gate temporary exiting process 34 is executed by the OS 11. At this time, if a signaling or interrupt 26 is generated while the application process 13 is executed from when the attribute value group 14 of the application process 13 is changed by the security gate entering process 31, to when the attribute value group 14 of the application process 13 is returned to the original state by the security gate temporary exiting process 34, the security gate temporary exiting process 34 is executed to returns the attribute value group 14 of the application process 13 to the state before the change by the security gate entering process 31 before calling interrupt handler 44/signaling of the application process 13 and to return the attribute value group 14 of the application process 13 to the state after the change by the security gate entering process 31.

Next, an operation of the information processing apparatus in the present exemplary embodiment will be described mainly on the difference from the first exemplary embodiment.

When the application process 13 calls the library function 12 through the call instruction 41, the first specific instruction 22 located at the head of the library function 12 is firstly executed and the attribute value group 14 of the application process 13 is changed by the security gate entering process 31 of the OS 11. Subsequently, when the privileged instruction 24 is executed by the application process 13 after a portion 21 for guaranteeing execution of processing is executed, the execution of a privileged instruction is judged by the privileged instruction execution control 33 of the OS 11 based on the attribute value group 14 of the application process 13. The privileged instruction 24 is executed when the execution is permitted or possible, the processing control is returned to a calling source of call. When a signal or an interrupt 26 is generated after that, internal interrupt is generated to shift the processing control to the OS 11, and the security gate temporary exiting process 34 is executed. The interrupt handler 44/signal of the application process 13 is called after the attribute value group 14 of the application process 13 is returned to the state before the change by the security gate entering process 31. When the processing by the signal/interrupt handler 44 ends, the processing control is returned to the security gate temporary exiting process 34 of the OS 11. The processing control is returned to a point suspended due to the signal or interrupt 26 of the library function 12 after the attribute value group 14 of the application process 13 is returned to the state after the change by the security gate entering process 31. When the processing of the library function 12 proceeds and the second specific instruction 23 is executed immediately before returning to the calling source, the attribute value group 14 of the application process 13 is returned to the state before security gate entry by the security gate exiting process 32 of the OS 11.

The operations when the application process 13 executes the instruction 42 by which the processing control directly jumps to the privileged instruction 24 of the library function 12 and when the application process 13 executes the privileged instruction 43 are the same as those of the first exemplary embodiment.

According to the present exemplary embodiment as mentioned above, it is possible to prevent unauthorized use of the privileged instructions 24 and 43 and the library function 12 by the application process 13 more surely, compared with the first exemplary embodiment.

### EXAMPLES

Next, examples of the present invention will be described in detail with reference to the drawings.

### Example 1 of First Exemplary Embodiment

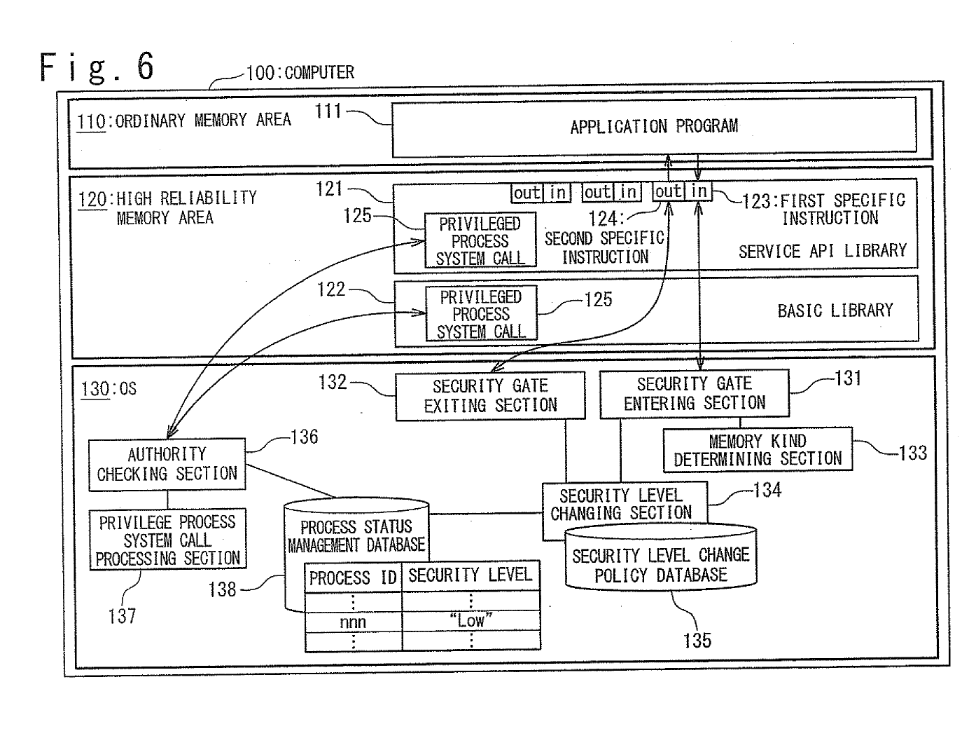

With reference to FIG. 6, the example 1 of the first exemplary embodiment of the present invention includes a computer 100, which operates through program control and has an ordinary memory area 110 and a high-reliability memory area 120. Additionally, an OS 130, which is a basic program, operates on the computer 100.

An application program 111 is located in the ordinary memory area 110. A reliable service API library 121 and a basic library 122 are located in the high-reliability memory area 120. Here, the high-reliability memory area 120 is a memory area having high reliability, in which stored data is less likely to be altered, opposite to the ordinary memory area 110. The basic library 122 is a library (e.g. libc) that provides basic functions used from various application programs 110 or library programs such as a file handling function, a character-string manipulating function, and a communication function. The service API library 121 is a library that includes an API function, which is directly called when the application program 110 uses service provided to the application program.

In case of the present example, the first specific instruction 123 and the second specific instruction 124 are located in the service API library 121. The service API library 121 or the basic library 122 includes a privilege process system call 125.

The OS 130 is provided with a security gate entering section 131, a security gate exiting section 132, a memory kind determining section 133, the security level changing section 134, a security level change policy database 135, an authority checking section 136, a privilege process system call processing section 137, and a process status management database 138. The OS 130 is Linux for example, and may be another kind of OS.

The ordinary memory area 110 is realized by a RAM and so forth, and can be used freely from the application program 111.

The application program 111 is a program with uncertain reliability, which is not included at the time of factory product shipment and added later. In general, the application program 111 is loaded from such a nonvolatile storage as a file system into the ordinary memory area 110 by the OS 130 and is executed as the application process.

The high-reliability memory area 120 is a memory area to which alteration cannot be applied from the application process. The most general method for realization is implementation of a ROM, which also may be a RAM that is set not to easily be altered from the application process under the management of the OS 130, namely, a RAM allocated as a memory space to which write authority from an application program is not granted. In this case, the service API library 121 and the basic library 122 are located by the OS 130 loading from a ROM or a file system into the high-reliability memory area 120. Additionally, in case of Linux, for instance, a memory space where a program code is stored is set to be write inhibition and such a memory space is applicable.

The service API library 121 provides various library functions to the application program 111 and has a plurality of API functions, which are called when the application program 111 uses the functions.

The first specific instruction 123 is implemented as a specific system call instruction, and is located at the head of the API function. When the application process calls the instruction 123, internal interrupt is generated and the security gate entering section 131 of the OS 130 is called.

The second specific instruction 124 is also implemented as a specific system call instruction, and is located at the end of the API function. When the application process calls the instruction 124, internal interrupt is generated and the security gate exiting section 132 of the OS 130 is called.

The basic library 122 is a library for providing more basic functions which the service API library 121 and so forth use.

The privilege process system call 125 calls a function of the OS 130 to achieve the function of the service API library 121 or the basic library 122 and is not provided with execution right in the security level of the application process with uncertain reliability. When the application process calls the privilege process system call 125, an internal interrupt is generated and the authority checking section 136 in the OS 130 is called. In case of the present exemplary embodiment, the security level of the application process includes two levels, which are “Low” (non-privileged level) and “High” (privileged level). Needless to say, application is possible to a computer with three or more levels, and such a terminal as a certain kind of cellular telephone which has four security levels of a device manufacturer level, a telecommunications carrier level, a reliable application vendor level, and a level with uncertain reliability.

The security gate entering section 131 judges whether the first specific instruction 123 is normally executed based on the result of the memory kind determining section 133, and changes the security level of the application process to a higher one by using the security level changing section 134 when the first specific instruction 123 is normally executed. On the other hand, the security level is not changed when the first specific instruction 123 is illegally executed.

The memory kind determining section 133 judges whether the first specific instruction 123 executed is in the high-reliability memory area 120. More specifically, an address range of the high-reliability memory area 120 is retained as a permissible address range, and an address of the first executed specific instruction 123 and the permissible address range are compared. It is judged that the first specific instruction 123 is within the high-reliability memory area 120 when the address of the first specific instruction 123 is within the permissible address range, and it is judged that the first specific instruction 123 is in the ordinary memory area 110 otherwise. Additionally, the memory kind determining section 133 also may verify that a memory address area in which the first specific instruction is present, and which is verified as a high-reliability memory area, is not in a data area but in a program code area, by referring to data managed by the OS 130. In such a case, it is possible to prevent a judgment mistake due to accidental pattern matching of data areas.

The setting of the above permissible address range is performed as mentioned in a) and b) below.

a) When the high-reliability memory area 120 is a ROM area, an address range of the ROM area is a permissible address range.
b) In case of a computer that loads a reliable service API library program from a file system or a ROM into a RAM area for execution, the memory address range loaded with the program is a permissible address range. Judgment of reliability of the service API library program to be loaded can use such methods as a method of retaining information indicating reliability of the file system or the ROM as a load source in advance and making judgment by referring thereto, a method of retaining a list of reliable service API library programs in advance and making judgment by referring thereto, and a method of attaching a mark (e.g. signature) to a reliable service API library program in advance and making verification at the time of loading.

The security gate exiting section 132 changes the security level of the application process back to an original level by using the security level changing section 134.

The process status management database 138 retains sets of a process ID for uniquely identifying the application process and the security level.

The security level changing section 134 changes a portion that shows the security level of the application process, in the process status management database 138 to change the security level of the application process in response to a request from the security gate entering section 131. At this time, the state before the change is retained in the process status management database 138 so that the state can be restored.

Here, it is also possible to provide the security level change policy database 135 retaining a changing rule so that the security level changing section 134 can change the security level of the application process in accordance with the changing rule retained in the database 135. For instance, more flexible change in the security level is possible by using the changing rule in which it is described to which level the security level is to be increased according to a kind, a feature, and an original security level of the application process and a changing rule where it is described to which level the security level is to be increased according to the state of a device (computer).

The security level changing section 134 performs a process for restoring the original security level of the application process in response to a request from the security gate exiting section 132.

The authority checking section 136 judges whether a privilege process system call requested for the OS 130 has authority of execution at the present security level of the application process as a calling source of request, by referring to the information of the process status management database 138, and performs s process by using the privilege process system call processing section 137 when the authority is present. When no authority is present, the requested system call is not executed and an error is generated.

The privilege process system call processing section 137 performs a process for the requested privilege process system call.

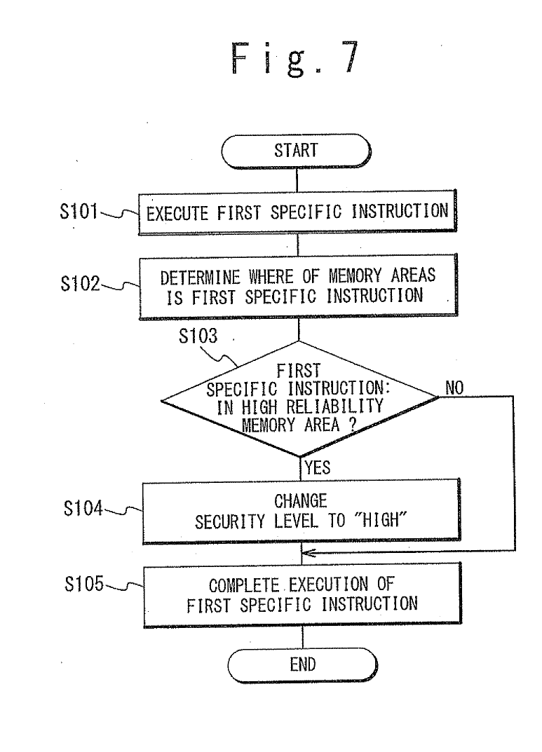

Next, an operation of the information processing apparatus in the present example will be described in detail with reference to FIG. 6 and the flow diagrams of FIGS. 7 to 9.

First, the application program 111 is loaded into the ordinary memory area 110 by the OS 130 and is executed as the application process (process ID=nnn). At this time, it is not certain whether the application process is reliable, which operates in the security level “Low”. The application process calls an API function provided by the service API library 121, when necessary, and the first specific instruction 123 located at the head of the API function is executed (step S101 in FIG. 7).

When the first specific instruction 123 is executed, the security gate entering section 131 in the OS 130 is called. The security gate entering section 131 finds out a type of the memory area where the first specific instruction 123 performing the call is present, by using the memory kind determining section 133 (step S102 in FIG. 7). Only when the found type of the memory area is the high-reliability memory area 120, the security level of the application process is changed to a higher one by using the security level changing section 134 (steps S103 and S104 in FIG. 7). As a result, a data concerning the security level of the application process in the process status management database 138 is changed from “Low” to “High”, for example. When the change of the security level of the application process is completed, the processing of the first specific instruction 123 is completed (step S114 in FIG. 7). When the type of the memory area is not the high-reliability memory area 120 at the step S103, the security level of the application process is not changed and the process for the first specific instruction 123 is completed (step S114 in FIG. 7).

After that, the application process executes a process for the service API library 121 and a program provided by the basic library 122 which the service API library 121 further calls, and the privilege process system call 125 is executed at this process.

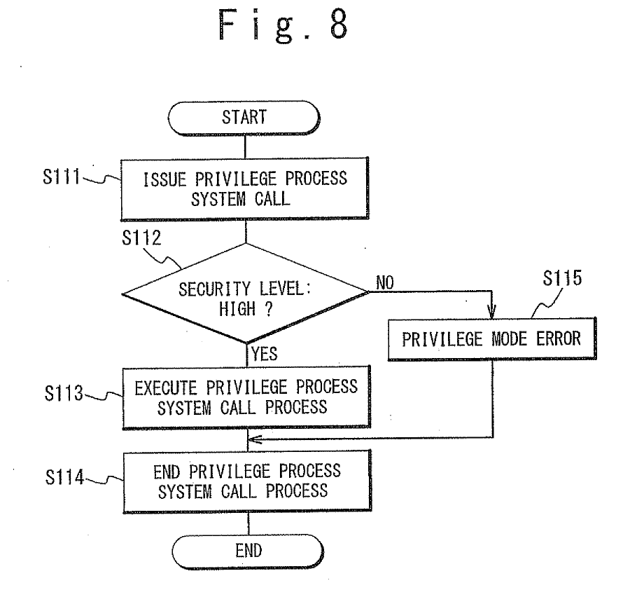

When the privilege process system call 125 is executed (step S111 in FIG. 8), the authority checking section 136 in the OS 130 is called. The authority checking section 136 refers to the security level of the application process in the process status management database 138, and performs privileged processing by using the privilege process system call processing section 137 in case of the “High” level (steps S112 and S113 in FIG. 8) to end the processing (step S114 in FIG. 8). When the security level of the application process is “Low” level, the privileged processing is not performed and a privileged mode error is returned (step S115 in FIG. 8) to end the processing (step S114 in FIG. 8).

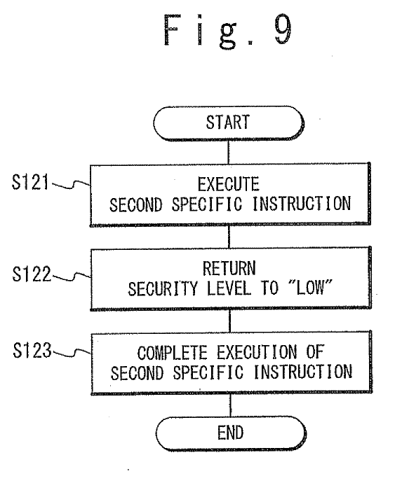

After that, the process for the service API library 121 is completed in the application process and the second specific instruction 124 is executed immediately before the processing control returns to the application program 111 (step S121 in FIG. 9).

When the second specific instruction 124 is executed, the security gate exiting section 132 in the OS 130 is called. The security gate exiting section 132 restores the original security level of the application process by using the security level changing section 134 (step S122 in FIG. 9). Here, the data concerning the security level of the application process in the process status management database 138 returns to “Low”.

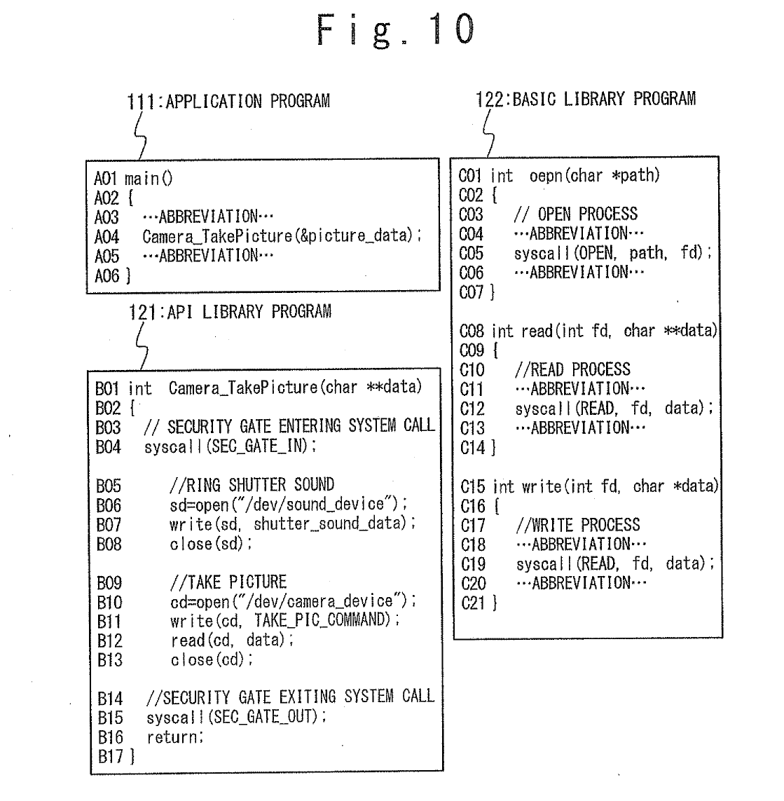

Next, specific examples of the application program 111, the service API library 121, and the basic library 122 will be described with reference to FIG. 10. The OS is Linux.

In the application program 111 with reference to FIG. 10, processing to be achieved by the application program 111 is written in the application program 111. The APT library program 121 provides the application program 111 with processing of ringing a shutter sound and taking a picture. The processing of ringing the shutter sound is also a portion for guaranteeing execution of processing. The basic library program 122 provides open, close, read and write functions to a device file. The application program 111 is located in the ordinary memory area 110 and the API library program 121 and the basic library program 122 are located in the high-reliability memory area 120. The application process is not provided with authority of operation to the device file and the authority of operation to the device file is to be given only in case of the security level changed at the time of security gate entry.

When the application process corresponding to the application program 111 is generated, processing starts from main ( ) function of step A01 in the application program 111. In order to take a picture during the processing, the application process calls Camera_TakePicture function provided by the API library program 121 (step A04). A security gate entry system call, which is the first specific instruction, is called at the head of the Camera_TakePicture function (step B04), and the security level of the application process is changed. After that, in order to ring a shutter sound, an open function of a sound device file is called (step B06), a shutter sound is generated by writing the shutter sound into the file (step B07), and a close function is called to close the sound device file (step B08). Subsequently, in order to take a picture, an open function of a camera device is called (step B10), a picture is taken by writing a photographing command into the file (step B11), a read function is called to gain an obtained picture (step B12), and then a camera device file is closed by calling the close function (step B13). Here, although the original application process was not provided with authority of operation to a device file, the operation to the device file is now legally processed since the security level has been changed after a security gate is gone through. After that, the API library program 121 calls a security gate exit system call, which is the second specific instruction, at the end of the Camera_TakePicture function (step B15), and returns to the application process after changing the security level of the application process back to the original level.

As mentioned above, the operation to a device file is possible only while the application process executes the Camera_TakePicture function, which is the service API function. When one function of the basic library program 122, e.g., an open function (step C01) is called to directly operate a device file from the application program, an error is generated since there is no entry into a security gate (that is, the first specific instruction is not executed). An error also is generated when the processing control directly jumps to step C05. An error also is generated when the application program 111 imitates an instruction of the step C05 (syscall (OPEN, path, fd)). When the application program 111 imitates an instruction of step B04 (syscall (SEC_GATE_IN)) to illegally change the security level, an error also is generated, since the instruction is not in a high-reliability memory area.

As a result, the application process cannot use the camera function provided by the basic library program 122 unless the application process normally uses the API library program 121. When the API library program 121 is normally used, the processing of ringing a shutter sound is performed without fail, making it possible to guarantee the execution of the processing. For instance, since the shutter sound is rung without fail at the time of camera photographing of a cellular telephone, it is possible to prevent an illegal operation such as a shutter operation without ringing the sound when access to the camera device is allowed to the application program 111 through an API library program in which execution of the processing of ringing the sound is guaranteed, like the API library program 121 of FIG. 10.

According to the present example as mentioned above, it is possible to safely provide the application process with uncertain reliability with a library function that includes a program code having no execution allowance in the security level set to the application process. Effect of the present example will be described specifically below with some specific application examples.

### Application Example 1

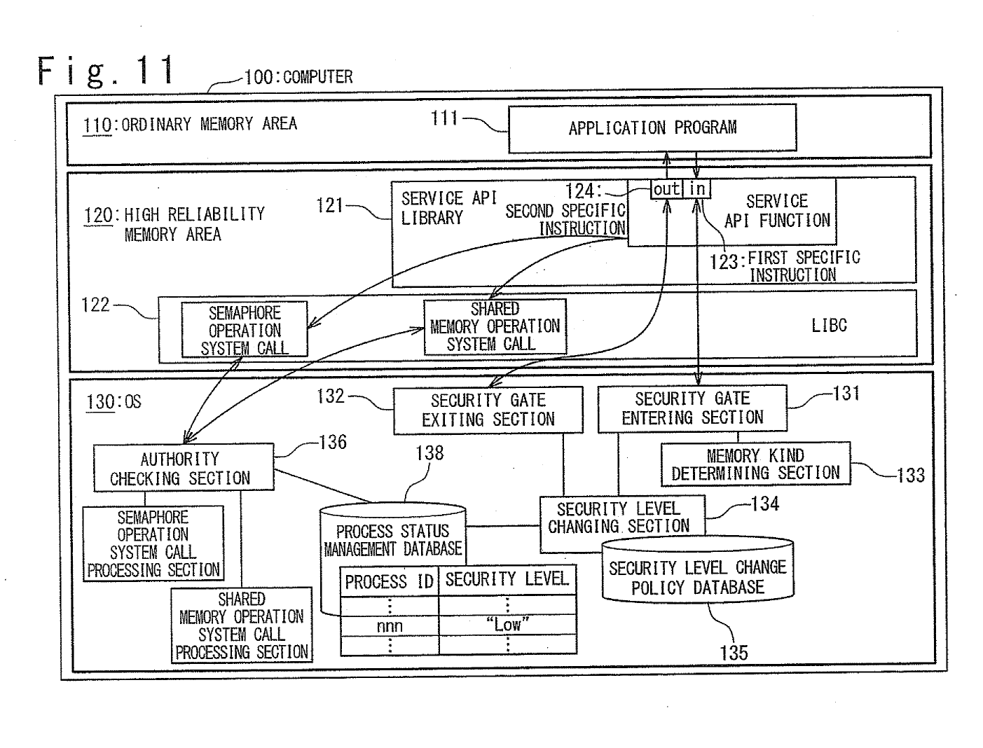

With reference to FIG. 11, in the present application example, libc is located as the basic library 122, and program codes of a shared memory operation system call instruction and a semaphore operation system call instruction are present in the libc. Processing of a service API function in the service API library 121 includes a program code that uses the shared memory operation system call instruction and the semaphore operation system call instruction in the libc. The application process is not provided with authority to use the system calls, which, when illegally used, have a possibility that a seriously adverse effect is affected on a whole system.

With the use of the mechanism of the present invention, semaphore operation and shared memory operation are possible only while the application process executes a service API function. In this case, an error is generated when the semaphore operation system call instruction and the shared memory operation system call instruction provided by the libc are directly called from an application program. For this reason, the service API function can be provided in which the operation arbitrary operations of the semaphore and shared memory by the application program are forbidden and these operations are used.

### Application Example 2

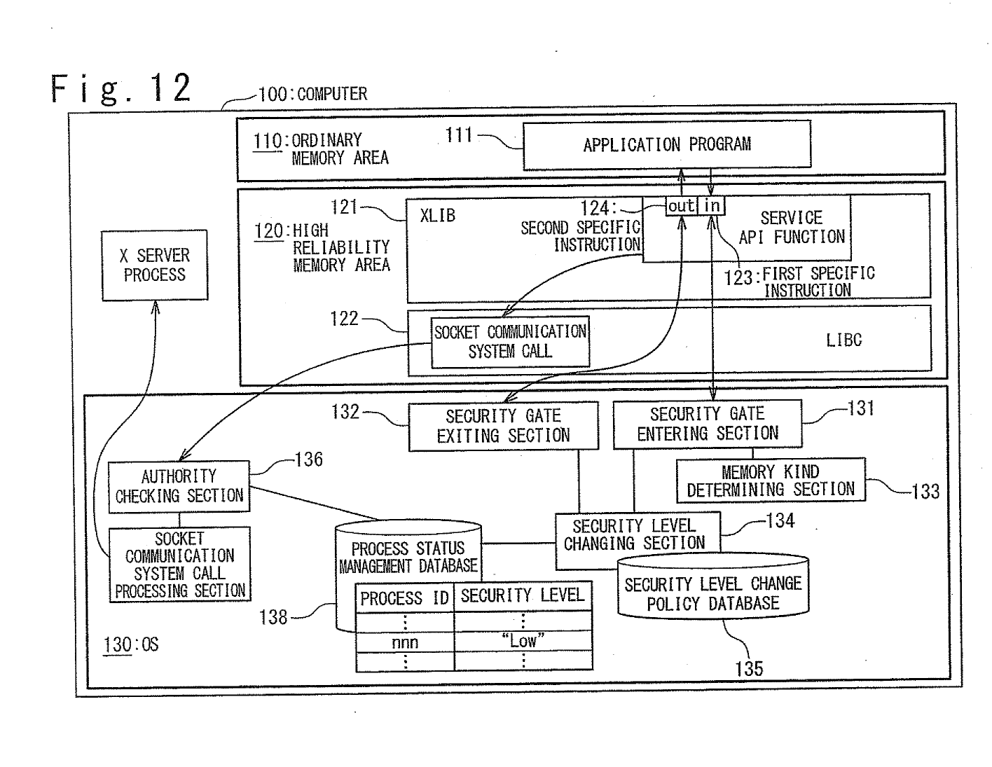

With reference to FIG. 12, a computer of the present application example provides X server/client as a GUI system provided to the application program 111. In the computer, libc is located as the basic library 122 and a program code of a socket communication system call instruction is present in the libc. Additionally, an X client library (xlib) is located as the service API library 121, in which a function including the socket communication system call instruction in the libc is called. The application process is not provided with authority to establish communication with the X server through the socket communication system call instruction.

With the use of the mechanism of the present invention, the application process can establish communication with the X server only through the xlib library in the high-reliability memory area 120. This makes it possible to prevent the application program from arbitrarily establishing communication with the X server without going through the xlib and giving adverse effect on the X server.

### Application Example 3

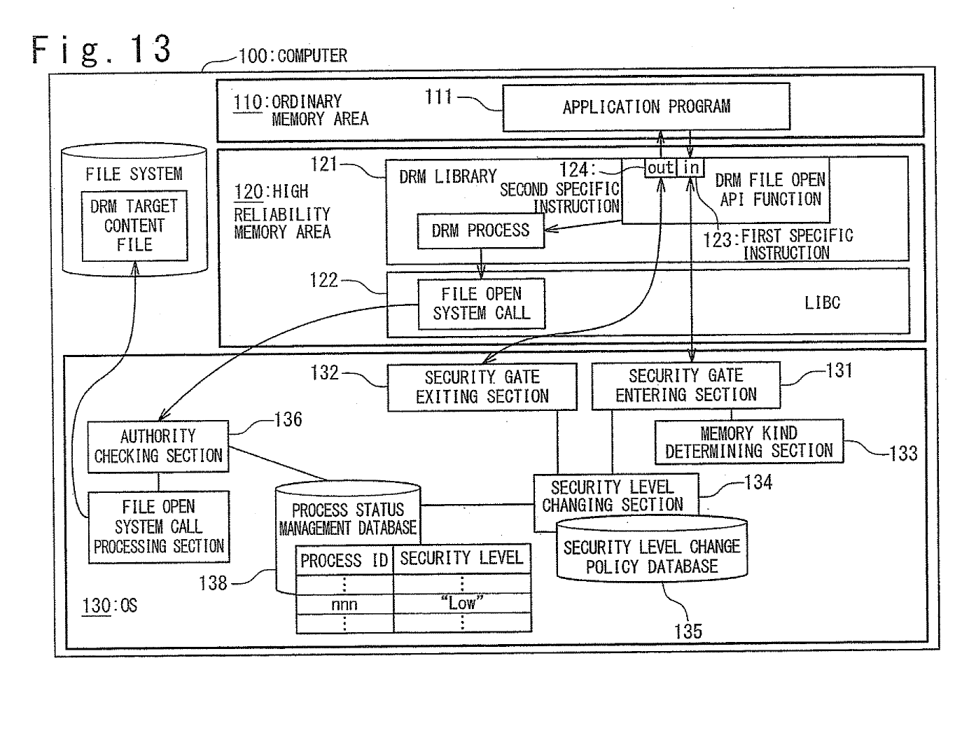

With reference to FIG. 13, a computer of the present application example provides such content service as image, music, and moving image under use authority management by DRM (Digital Rights Management). In the computer, libc is located as the basic library 122 and a program code of a file open system call instruction is present in the libc. Additionally, a DRM library is located as the service API library 121, in which DRM processing is performed and a function including the file open system call instruction in the libc is called. In the computer, there is a file system that includes target content under DRM management. The application process is not provided with authority to open the target content of DRM management.

With the use of the mechanism of the present invention, the application process can open the target content of DRM management only when the DRM processing is appropriately performed through the DRM library. It is possible to prevent the target content under DRM management from being arbitrarily opened in the application program, thereby having an effect that encryption of the target content under DRM management is unnecessary, which has conventionally been necessary.

### Application Example 4

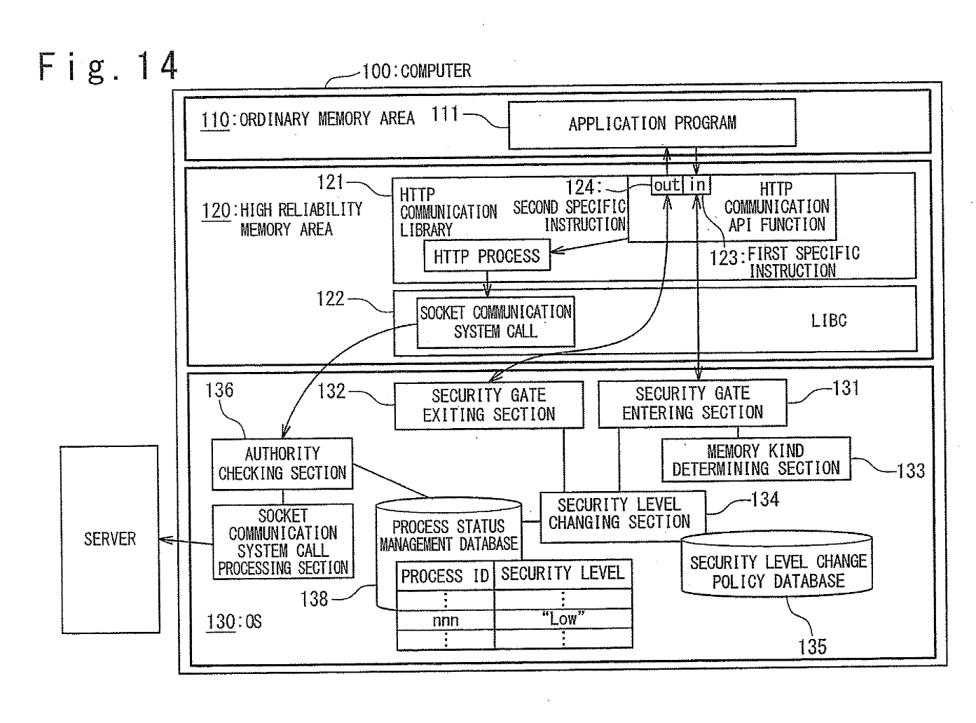

With reference to FIG. 14, a computer of the present application example provides service to establish communication with a system (server) outside the computer. In the computer, libc is located as the basic library 122 and a program code of a socket communication system call instruction is present in the libc. Additionally, an HTTP communication library is located as the service API library 121, in which HTTP processing is performed and a function for issuing the socket communication system call is called. The application process is not provided with authority to execute the socket communication system call.

With the use of the mechanism of the present invention, it is possible to set a condition such that the application process can communicate with an external server only through the HTTP communication library. By such setting, it is possible to prevent arbitrary communication with an external server performed in the application program, communication performed by the application process with the external server using an illegal protocol, HTTP communication using an illegal parameter through unique HTTP processing of the application program, and so forth.

### Example 2 of First Exemplary Embodiment

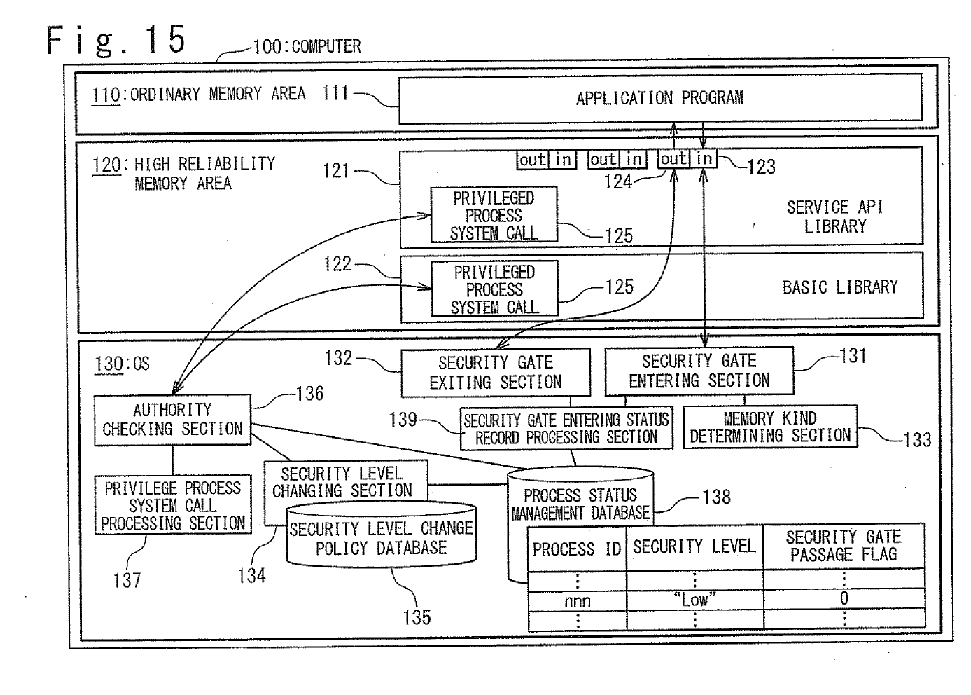

With reference to FIG. 15, the example 2 of the first exemplary embodiment of the present invention is different from the example 1 in that an attribute value that shows a security gate entering state is added as a new attribute value of the application process. Also, the process status management database 138 retains sets of a process ID, the security level, and a security gate passage flag corresponding to the above-mentioned attribute value. A security gate entering status record processing section 139 having a function of changing the security gate passage flag in the process status management database 138 is provided. Moreover, the security level is not changed when the application process enters a security gate and the security gate entering state is managed by using the security gate passage flag, to temporarily change the security level at the time of authority check of privileged instruction execution by the authority checking section 136.

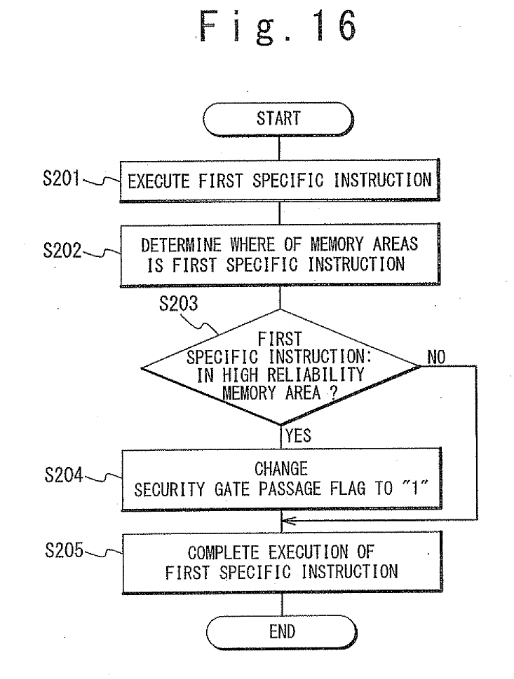

Next, an operation of the present example will be described in detail with reference to FIG. 15 and flow diagrams of FIGS. 16 to 18.

First, the application program 111 is loaded into the ordinary memory area 110 by the OS 130, and executed as the application process (process ID=nnn). At this time, it is not certain whether the application process can be reliable, and the application process operates in the security level of “Low”. A security gate passage flag is “0”. The application process, when necessary, calls an API function provided by the service API library 121, in which the first specific instruction 123 located at the head of the API function is executed (step S201 in FIG. 16).

When the first specific instruction 123 is executed, the security gate entering section 131 in the OS 130 is called. The security gate entering section 131 finds out a type of the memory area where the first specific instruction 123 issuing the call is present, by using the memory kind determining section 133 (step S202 in FIG. 16). Only when the found type of the memory area is the high-reliability memory area 120, it is recorded by using the security gate entering status record processing section 139, that the application process is in a security gate entering state (steps S203 and S204 in FIG. 16). As a result, the security gate passage flag of the application process in the process status management database 138 is changed from “0” to “1.”, for example. After the change of the security gate passage flag of the application process is completed, the processing of the first specific instruction 123 is completed (step S205 in FIG. 16). On the other hand, when the memory area where the first specific instruction 123 is present, is not the high-reliability memory area 120 (No at the step S203 in FIG. 16), the processing of the first specific instruction 123 is completed without changing the security gate passage flag of the application process (step S205 in FIG. 16).

After that, the application process performs processing of the service API library 121 and a program provided by the basic library 122 and called by the service API library 121. At this process, the privilege process system call instruction 125 is executed.

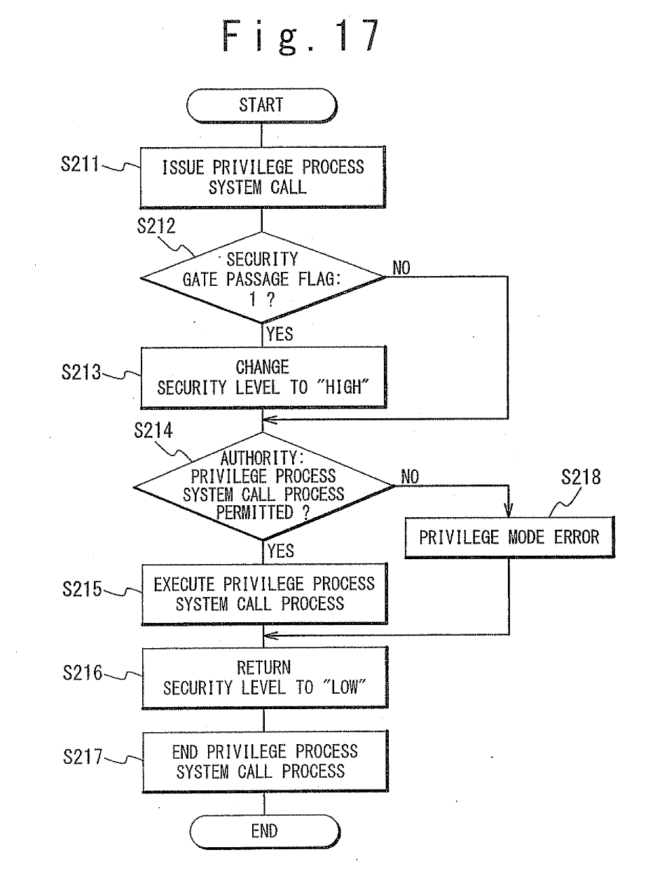

When the privilege process system call instruction 125 is executed (step S211 in FIG. 17), the authority checking section 136 in the OS 130 is called. The authority checking section 136 refers to the security gate passage flag of the application process in the process status management database 138. In case of “1”, the authority checking section 136 changes the security level of the application process to “High” by using the security level changing section 134 (steps S212 and S213 in FIG. 17). Next, it is checked whether the application process keeps authority to process a privilege process system call instruction based on the changed security level. When the authority is kept, privileged processing is performed by using the privilege process system call processing section 137 (steps S214 and S215 in FIG. 17). When authority is not kept, the privileged processing is not performed and a privileged mode error is generated (step S218 in FIG. 17). After that, the security level of the application process is returned to “Low” by using the security level changing section 134 again and the privilege process system call processing ends (steps S216 and 217 in FIG. 17).

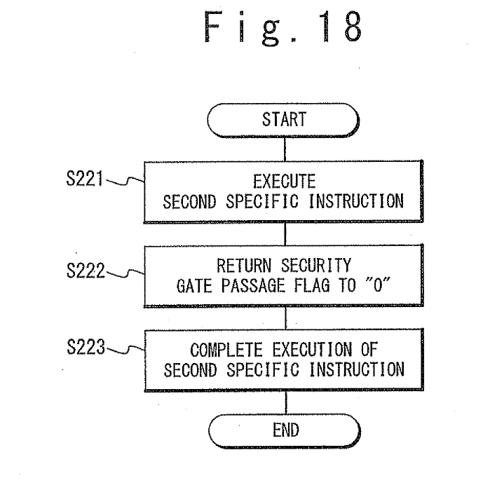

After that, the second specific instruction 124 is executed immediately before the processing control returns to the application program 111 after the application process completes the processing of the service API library 121 (step S221 in FIG. 18).

When the second specific instruction 124 is executed, the security gate exiting section 132 in the OS 130 is called. The security gate exiting section 132 restores the original security gate passage flag for the application process by using the security gate entering status record processing section 139 (step S222 in FIG. 18). As a result, the security gate passage flag for the application process an the process status management database 138 is returned to “0”.

According to the example 2 of the first exemplary embodiment as mentioned above, a safer operation is possible since an interval where the security level of the application process is set to the “High” can be defined shorter, compared with the example 1 of the first exemplary embodiment.

In addition, the security level change policy can be retained in units of privilege process system calls in the security level change policy database 135, more flexible change in the security level is possible. For instance, when several kinds of privilege process system call instructions appear from entry to exit of a security gate, and some of them include special instructions (e.g. power reset) which must not be used by an unidentifiable application process at any time, it is possible to exclude only the places of the special instructions from targets of security level change.

### Modification Example of Example 2 of First Exemplary Embodiment

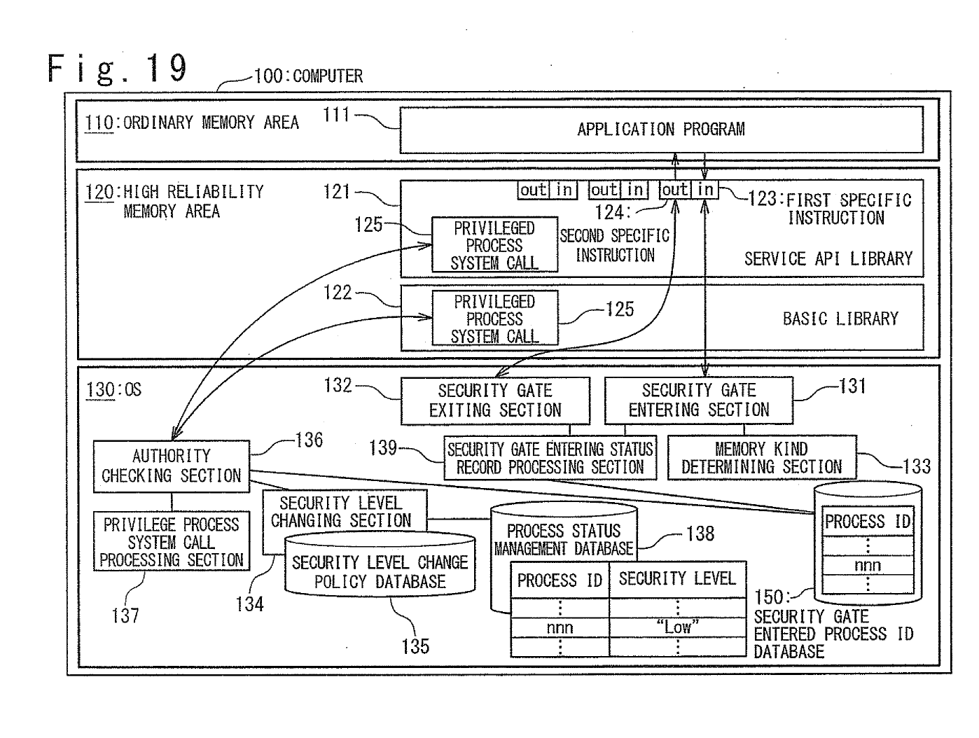

It is managed whether the application process is in a security gate entering state, based on a flag provided in the process status management database that retains the security level corresponding to a process ID of each application process in the present example at least. A security gate entered process ID database 150 may be provided to manage a list of process IDs of application processes in a security gate entering state, as shown in FIG. 19. In this case, the security gate entering state record processing section 139 records a process ID of the application process requested from the security gate entering section 131 in the database 150, and performs deletion of a process ID of the application process requested from the security gate exiting section 132 from the database 150. The authority checking section 136 checks whether or not a process ID of the application process as an authority check target is recorded in the database 150, judging whether or not the application process is in a security gate entering state.

### Example 3 of First Exemplary Embodiment

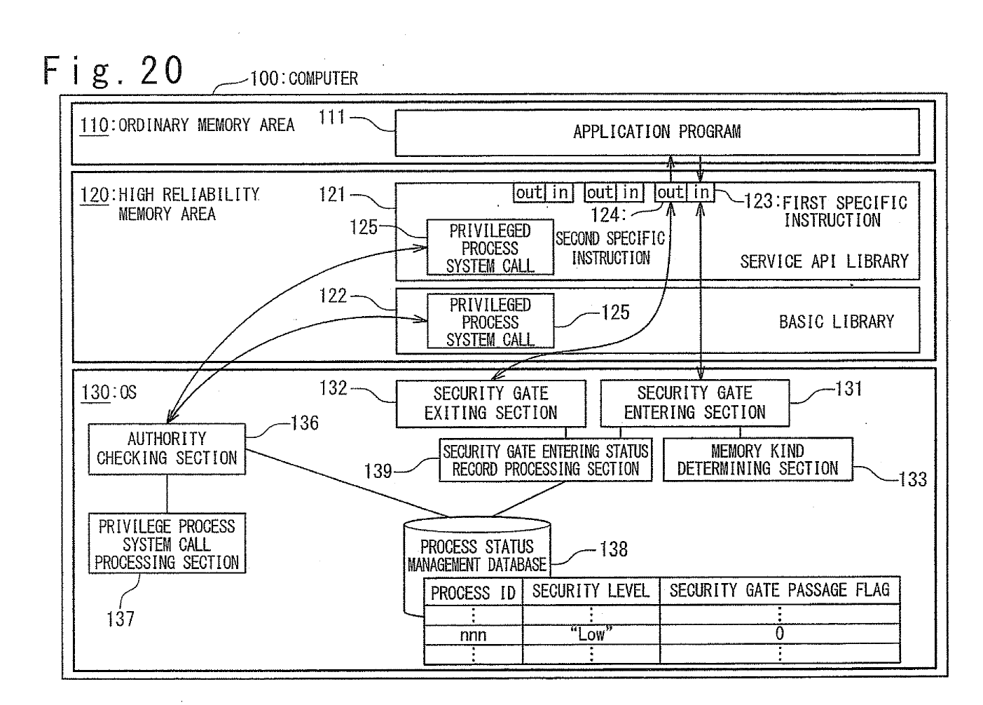

With reference to FIG. 20, the example 3 of the first exemplary embodiment of the present invention is different from the example 2 in that the security level changing section 134 and the security level change policy database 135 are omitted from the configuration of the example 2 of the first exemplary embodiment shown in FIG. 15. Also, when the application process is in a security gate entering state, the authority checking section 136 omits an authority checking operation through the security level of the application process and executes a privileged instruction. Moreover, when the application process is not in a security gate entering state, the authority checking section 136 performs the authority checking operation through the security level of the application process and executes a privileged instruction when authority to execute the privileged instruction is granted, while an error is generated as a privileged instruction violation when the authority to execute the privileged instruction is not granted.

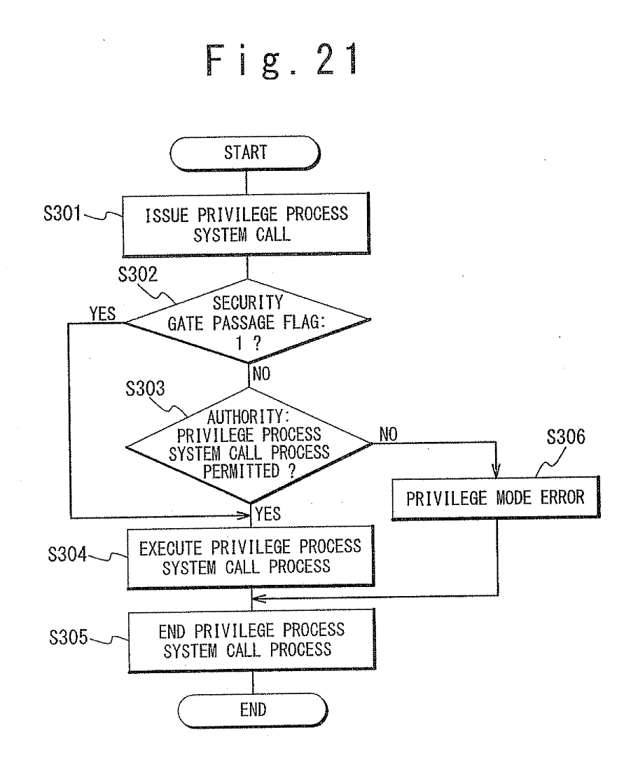

Next, an operation of the present example will be described in detail with reference to FIG. 20 and a flow diagram of FIG. 21.

First, the application program 111 is loaded into the ordinary memory area 110 by the OS 130, and executed as the application process (process ID=nnn). At this time, it is not certain whether the application process is reliable, and the application process operates in the security level “Low”. The application process calls an API function provided by the service API library 121, if necessary, and the first specific instruction 123 located at the head of the API function is executed. The operation at this time is the same as in case of the example 2 of FIG. 15. Consequently, the security gate passage flag of the application process in the process status management database 138 is changed from “0” to “1”, for example, only when the memory area where the first specific instruction 123 is present, is the high-reliability memory area 120.

After that, the application process performs processing of the service API library 121 and executes a program provided by the basic library 122 called by the service API library 121. In this process, the privilege process system call instruction 125 is executed.

When the privilege process system call instruction 125 is executed (step S301 in FIG. 21), the authority checking section 136 in the OS 130 is called. The authority checking section 136 refers to the security gate passage flag of the application process in the process status management database 138. In case of the flag of “1”, the authority checking section 136 passes authority check based on the security level to perform privileged processing by using the privilege process system call processing section 137, completing the privilege process system call processing (steps S302, S304, and S305 in FIG. 21). On the other hand, when the security gate passage flag is in “0” (NO at step S302 in FIG. 21), it is checked whether the application process retains authority to execute a privilege process system call instruction, based on the security level of the application process. The privileged processing is performed by using the privilege process system call processing section 137 when the authority is retained. Thus, the privilege process system call processing is ended (steps S303 to S305 in FIG. 21). When the authority is not retained, however, the privileged processing is not performed, causing a privileged mode error (steps S303 and S306 in FIG. 21).

After that, when the application process completes the processing of the service API library 121, and the second specific instruction 124 is executed immediately before the processing control returns to the application program 111, the security gate passage flag of the application process in the process status management database 138 is returned to “0” as in case of the example 2 of FIG. 15.

According to the example 3 of the first exemplary embodiment as mentioned above, since the processing relevant to security level change is not performed, effects can be obtained that a configuration is simpler so that implementation is easier, while processing speed is improved although fine control is impossible, compared with the examples 1 and 2 of the first exemplary embodiment.

It should be noted that although it is managed whether the application process is in a security gate entering state, based on a flag provided in the process status management database that retains the security level corresponding to a process ID of each application process in the present example at least. However, the security gate entered process ID database 150 may be provided to manage a list of process IDs of application processes in a security gate entering state, as in case of the example shown in FIG. 19.

### Example 4 of First Exemplary Embodiment

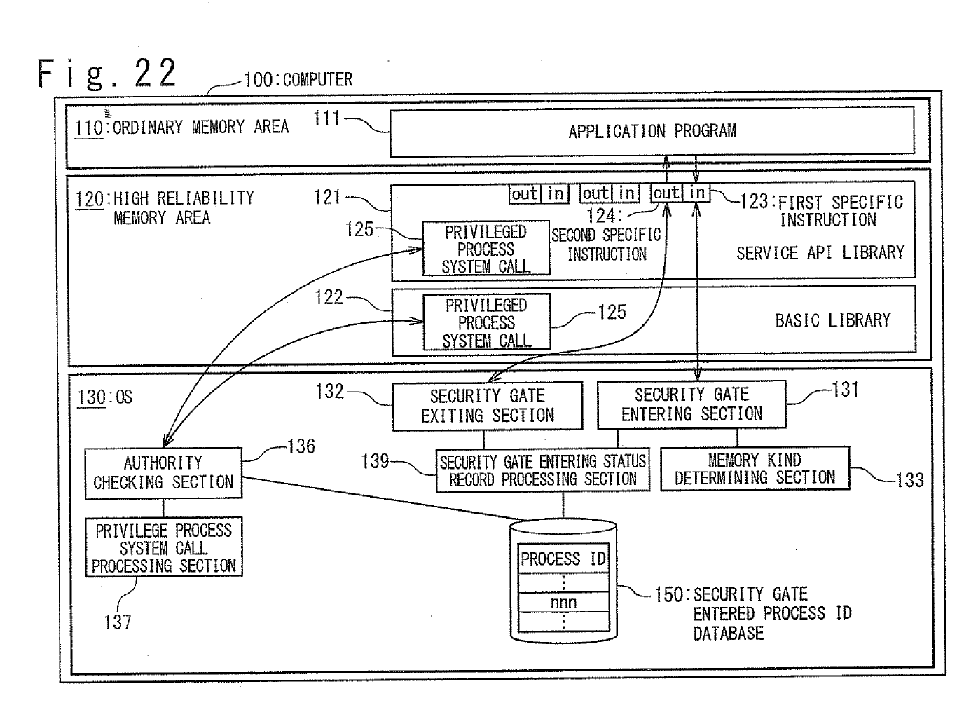

With reference to FIG. 22, the example 4 of the first exemplary embodiment of the present invention is different from the example 2 in that the security level changing section 134, the security level change policy database 135, and the process status management database 138 are omitted from the configuration of the example 2 of the first exemplary embodiment shown in FIG. 15. The security gate entered process ID database 150 is added to manage a list of process IDs of application processes in a security gate entering state. The authority checking section 136 determines and controls whether execution of a privileged instruction is possible or not, depending on whether or not the application process is in a security gate entering state.

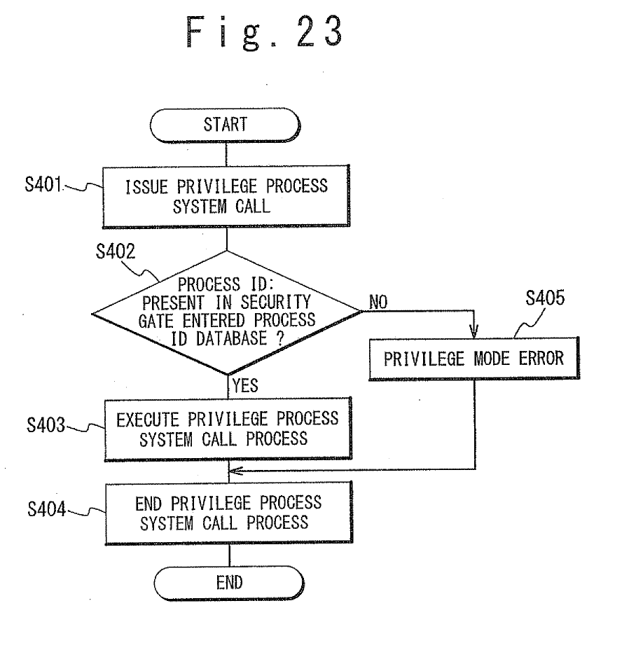

Next, an operation of the present example will be described in detail with reference to FIG. 22 and a flow diagram of FIG. 23.

First, the application program 111 is loaded into the ordinary memory area 110 by the OS 130, and executed as the application process (process ID=nnn). In the present example, setting of the security level to the application process is not essential and any security level may be set. The application process calls an API function provided by the service API library 121, if necessary, and the first specific instruction 123 located at the head of the API function is executed. The operation at this time is the same as in case of the modification example of the example 2 in FIG. 19. Consequently, a process ID of the application process is registered in the security gate entered process ID database 150, only when the memory area where the first specific instruction 123 is present, is the high-reliability memory area 120.

After that, the application process performs the processing of the service API library 121 and executes a program provided by the basic library 122 called by the service API library 121. In this process, the privilege process system call instruction 125 is executed.

When the privilege process system call instruction 125 is executed (step S401 in FIG. 23), the authority checking section 136 in the OS 130 is called. The authority checking section 136 checks whether or not a process ID of the application process is registered in the security gate entered process ID database 150. When determined to be registered, the authority checking section 136 performs privileged processing by using the privilege process system call processing section 137 and end the privilege process system call processing (steps S402 to S404 in FIG. 23). On the other hand, when the process ID is not registered (NO at the step S402 in FIG. 23), the privileged processing is not performed and a privileged mode error is generated (step S305 in FIG. 23).

After that, when the second specific instruction 124 is executed immediately before the processing control returns to the application program 111 after the application process completes the processing of the service API library 121, the process ID of the application process is deleted from the security gate entered process ID database 150 as in case of the modification example of the example 2 in FIG. 19.

According to the example 4 of the first exemplary embodiment as mentioned above, processing relevant to security levels is not performed, and effects can be obtained that a configuration is simpler, so that implementation is easier. However, processing speed is improved since fine control is impossible, compared with the examples 1 and 2 of the first exemplary embodiment.

It is managed whether the application process is in a security gate entering state, based on the security gate entered process ID database 150 in the present example. However, it may also be managed based on a flag provided in the process status management database that retains the security level corresponding to a process ID of each application process at least, as in case of the example 2 of the first exemplary embodiment.

### Example 1 of Second Exemplary Embodiment

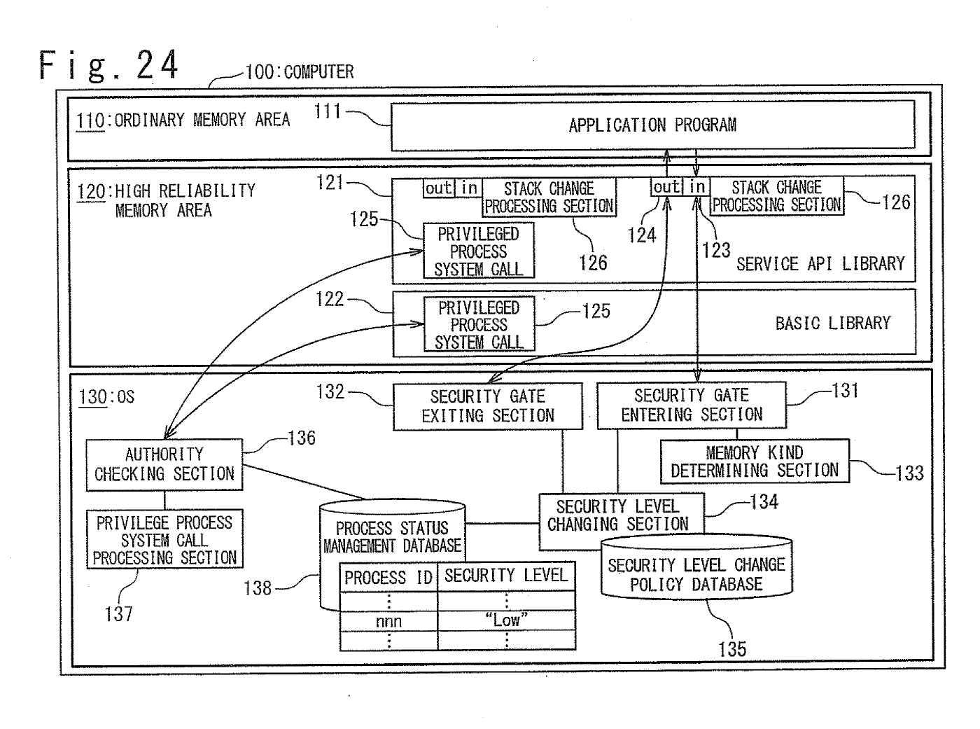

With reference to FIG. 24, the example 1 of the second exemplary embodiment is different from the example 1 of the first exemplary embodiment in that a stack change processing section 126 is added to each API function, in which the section 126 is an instruction sequence for changing a stack of the application process to necessarily go through a function that includes the second specific instruction 124 immediately before the processing control returns to an application program when the first specific instruction 123 is executed, while the second specific instruction 124 located at the end of processing of each API function present in the service API library 121 is omitted.

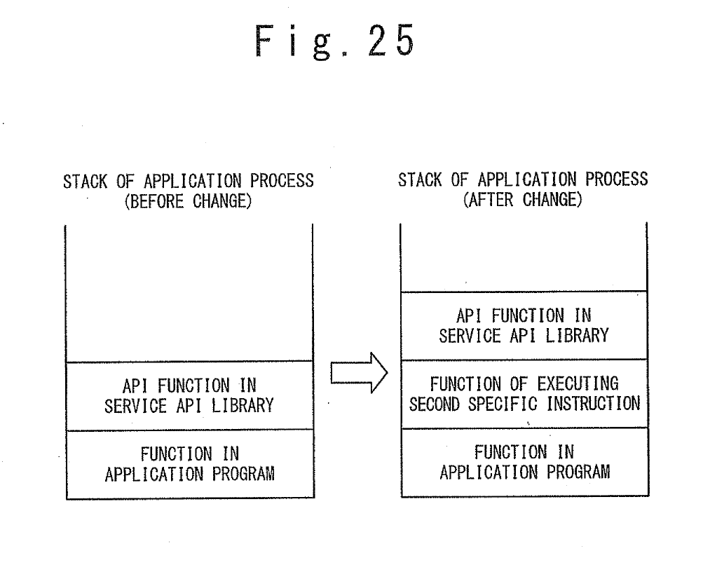

Next, an operation of the present example will be described in detail with reference to FIGS. 24 and 25.

First, the application program 111 is loaded into the ordinary memory area 110 by the OS 130, and executed as the application process (process ID=nnn). At this time, it is not certain whether the application process is reliable, and therefore, the application process operates at the security level “Low”. The application process calls an API function provided by the service API library 121, if necessary, and the first specific instruction 123 located at the head of the API function is executed. As a result, the security level of the application process is changed from “Low” to “High”, for example, by using the security level changing section 134, only when a type of the memory area where the first specific instruction 123 is present, is the high-reliability memory area 120, as in case of the example 1 of the first exemplary embodiment. After that, the stack change processing section 126 is executed to change stack data of the application process, and stack data of a function for executing the second specific instruction is inserted between stack data of an API function in the service API library and stack data of a function in the application program, as shown in FIG. 25. By changing the stack data as mentioned above, the function for executing the second specific instruction 124 is necessarily called before the processing control returns to the function in the application program after the application process ends the processing of an API function in the service API library.

When the function for executing the second specific instruction 124 is called and the second specific instruction 124 is executed, the security level of the application process is returned to “Low” by using the security level changing section 134 as in case of the example 1 of the first exemplary embodiment. The processing control is then returned to the application program according to stack data.

According to the example 1 of the second exemplary embodiment as mentioned above, the function for executing the second specific instruction 124 is necessarily called before the processing control is returned to the function in the application program after the application process ends the processing of an API function in the service API library as a result of the stack change processing. Thus, it is made possible to prevent an illegal leakage of privileged level due to a placement mistake of the second specific instruction 124.

The mechanism in which the second specific instruction 124 is necessarily executed as a result of the stack change processing in a same way as the present example, can be applied to the other examples excluding the example 1 of the first exemplary embodiment. Additionally, as described in the modification example of the second exemplary embodiment, it is also possible to provide stack change processing as one function of the OS 130 and perform the stack change processing in the security gate entering section 131 which is called at the time of execution of the first specific instruction 123.

### Example 1 of Third Exemplary Embodiment

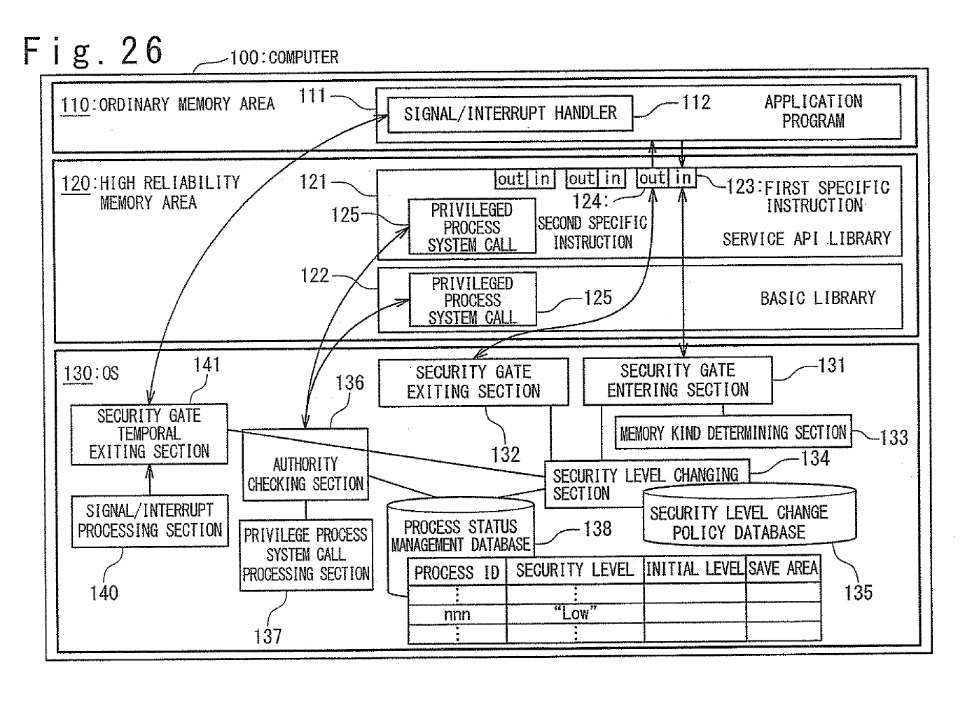

In the example 1 of the third exemplary embodiment with reference to FIG. 26, a signal/interrupt handler 112, a signal/interrupt processing section 140, and a security gate temporary exiting section 141 are added to the configuration of the example 1 of the first exemplary embodiment. The process status management database 138 stores sets of a process ID of the application process, a current security level, the security level (initial level) originally allocated at the time of process creation, and a storage zone of the security level.

The signal/interrupt handler 112 is present in the application program 111, and performs processing corresponding to a signal or interrupt that is generated while the application process is running.

The signal/interrupt processing section 140 is present in the OS 130, suspends ongoing processing when a signal or interrupt is generated while the application process is running, and calls the signal/interrupt handler 112 in the application program by way of the security gate temporary exiting section 141.

The security gate temporary exiting section 141 performs processing for temporarily restoring the original security level of the application process before the signal/interrupt processing section 140 calls the signal/interrupt handler 112 in the application program.

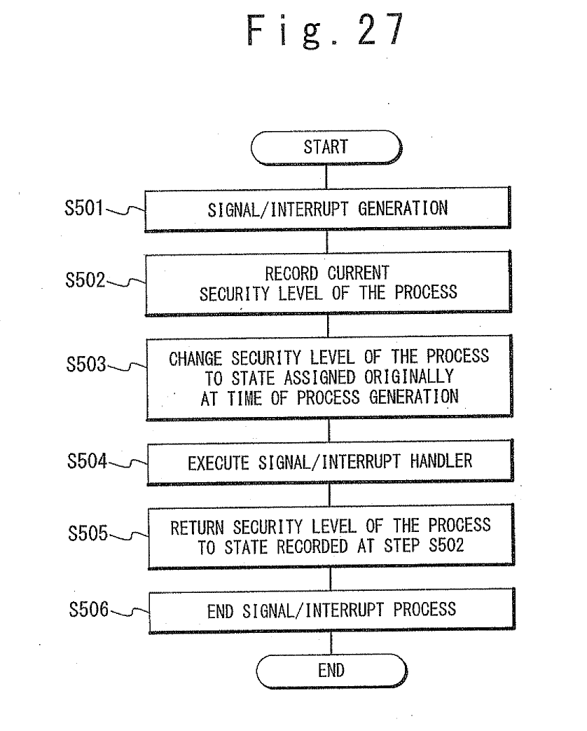

Next, an operation of the present example will be described in detail with reference to FIG. 26 and a flow diagram of FIG. 27.

When a signal or interrupt is generated while the application process performs processing in the case where the computer 100 operates through the processing operation described in the example 1 of the first exemplary embodiment, the OS 130 temporarily suspends the processing of the application process and calls the signal/interrupt handler 112 in the application program 111 by using the signal/interrupt processing section 140. At this time, when the application process is in a state to have gone through a security gate entering section 131 and the application process is in the privileged state, a dangerous situation in terms of security is brought since a program code in the application program will be executed under the privileged state. To prevent the aforementioned in the present example, processing for temporarily restoring the original security level of the application process is performed as described below by using the security gate temporary exiting section 141 before the signal/interrupt processing section 140 calls the signal/interrupt handler 112.

When a signal or interrupt is generated during processing by the application process (step S501 in FIG. 27), the signal/interrupt processing section 140 calls the security gate temporary exiting section 141. The security gate temporary exiting section 141 records the current security level of the application process in a storage zone of the process status management database 138 (step S502 in FIG. 27). Next, the security level of the application process is changed to the security level that is originally allocated at the time of process creation (step S503 in FIG. 27). After that, the signal/interrupt handler 112 in the application program 111 is called (step S504 in FIG. 27).

When the processing of the signal/interrupt handler 112 is ended, the processing control is returned to the security gate temporary exiting section 141 and the security gate temporary exiting section 141 changes the security level of the application process back to the security level recorded in the storage zone of the process status management database 138 (step S505 in FIG. 27). After that, the processing control is returned to the signal/interrupt processing section 140 and the signal/interrupt processing ends (step S506 in FIG. 27).

According to the present example as mentioned above, it is possible to prevent an illegal leakage of privileged state since the security level of the application process can temporarily be changed back to a state originally allocated to the application process even when a signal or interrupt is generated in the application process in privileged state that has gone through a security gate so that a handler in an application program is executed.

It should be noted that the mechanism to temporarily restore the original security level of the application process with the signal/interrupt handler 112 being executed can be applied to the other examples excluding the first example of the first exemplary embodiment and the other exemplary embodiments excluding the first exemplary embodiment, as in case of the present example,

The present invention can be applied to a case that an application program with uncertain reliability is safely added to a data processing apparatus. Here, the applicable data processing apparatus includes personal computers, embedded computers such as mobile communications terminals like a cellular telephone and a PDA, game consoles, and multifunctional copying machines.

1. An information processing apparatus comprising:
a storage section configured to store the application process, an attribute value group thereof, a library function, and an permissible address range of the first specific instruction, wherein in said library function, a first specific instruction is executed before execution of a portion for guaranteeing execution of processing performed in said library function, and a second specific instruction is executed before returning to a calling source of a call;
a privileged instruction execution controlling section configured to determine whether execution of a privileged instruction is permissible or not, based on the attribute value of the application process when internal interrupt is generated after the application process executes the privileged instruction;
a security gate entering section configured to check whether an address of the first specific instruction is in the permissible address range when the internal interrupt is generated after the application process executes the first specific instruction, and to change the attribute value group of the application process if the address of the first specific instruction is in the permissible address range; and
a security gate exiting section configured to restore the attribute value of the application process when the application process executes the second specific instruction and the internal interrupt is generated.

2. The information processing apparatus according to claim 1, wherein the attribute value group indicates the security level of the application process.

3. The information processing apparatus according to claim 2, wherein said privileged instruction execution controlling section performs an authority check by using the security level of the application process, and executes the privileged instruction when authority is granted to execute the privileged instruction.

4. The information processing apparatus according to claim 1, wherein the attribute value group indicates a security gate entry state of the application process.

5. The information processing apparatus according to claim 4, wherein said privileged instruction execution controlling section executes the privileged instruction when the application process is in the security gate entry state.

6. The information processing apparatus according to claim 1, wherein the attribute value group comprises an attribute value indicating the security level of the application process and an attribute value indicating the security gate entry state of the application process.

7. The information processing apparatus according to claim 6, wherein said privileged instruction execution controlling section omits the authority check based on the security level of the application process when the application process is in the security gate entry state, and executes the privileged instruction, and performs the authority check based on the security level of the application process when the application process is not in the security gate entry state and executes the privileged instruction when the authority to execute the privileged instruction is granted.

8. The information processing apparatus according to claim 6, wherein said security gate entering section changes the security level of the application process in the security gate entry state,
said security gate exiting section restores the security level of the application process in the security gate exit state, and
said privileged instruction execution controlling section performs the authority check based on the security level of the application process and executes the privileged instruction when the authority to execute the privileged instruction is granted.

9. The information processing apparatus according to claim 6, wherein said privileged instruction execution controlling section performs the authority check based on the security level of the application process after updating the security level of the application process when the application process is in the security gate entry state, and restores the security level back to an original level after executing the privileged instruction when the authority to execute the privileged instruction is granted.

10. The information processing apparatus according to claim 7, further comprising:
a security gate temporary exiting section configured to change the security level of the application process to an original level before the security gate entry state, before calling a signal/interrupt handler of the application process, when a signal or interrupt is generated during running of the application process in the security gate entry state, and restoring the security level after the security gate entry state when or after processing by the signal/interrupt handler ends.

11. The information processing apparatus according to claim 1, further comprising:
a security gate temporary exiting section configured to restore the attribute value group of the application process back to the attribute value group before change by said security gate entering section, before calling signal/interrupt handler of the application process, when a signal or interrupt is generated during running of the application process until the attribute value group of the application process is restored by said security gate exiting section, after the attribute value group of the application process is changed by said security gate entering section, and to restore the attribute value group after the change by said security gate entering section when or after processing by the signal/interrupt handler ends.

12. The information processing apparatus according to claim 2, wherein said security gate entering section changes a security level of the application process to a privileged level.

13. The information processing apparatus according to claim 2, further comprising:
a security level change policy database configured to store the security level changing rule, wherein said security gate entering section changes the security level of the application process based on the security level changing rule.

14. The information processing apparatus according to claim 4, wherein the attribute value group indicating the security gate entry state of the application process is recorded as one flag of said process management database which stores one security level corresponding to a process ID of each application process at least.

15. The information processing apparatus according to claim 4, further comprising:
a database configured to manage a list of application processes in the security gate entry state,
wherein the attribute value group indicating the security gate entry state of the application process is determined based on whether or not the process ID is recorded in said database.

16. The information processing apparatus according to claim 1, wherein the library function comprises the first specific instruction located before processing description for guaranteeing execution and the second specific instruction located before an exit returning to the calling source.

17. The information processing apparatus according to claim 1, wherein the library function comprises the first specific instruction located before processing description for guaranteeing execution, and an instruction sequence located on a processing control that is necessarily executed after the first specific instruction, to change a stack of the application process so as to go through a function including the second specific instruction, before returning to the calling source.

18. The information processing apparatus according to claim 1, wherein said library function has the first specific instruction located before processing description for guaranteeing execution, and
said security gate entering section changes a stack of the application process such that the application process goes through a function that includes the second specific instruction, before returning to the calling source, when the attribute value group of the application process is changed.

19. The information processing apparatus according to claim 1, wherein a predetermined address range is within a ROM area.

20. The information processing apparatus according to claim 1, wherein a predetermined address range is an address range on a RAM area of the library function loaded from a ROM area into the RAM area.

21. The information processing apparatus according to claim 1, wherein a predetermined address range is an address range on a RAM area of the library function loaded from a reliable file system into the RAM area.

22. The information processing apparatus according to claim 1, wherein a predetermined address is an address range on a RAM area of a reliable library function loaded from a file system into the RAM area.

23. The information processing apparatus according to claim 1, wherein when internal interrupt is generated after the application process executes the first specific instruction, the security gate entering section performs a check of whether or not the address of the first specific instruction is in a program area in addition to a check of whether or not the address of the first specific instruction is within the permissible address range.

24. The information processing apparatus according to claim 1, wherein the first specific instruction and the second specific instruction are system call instructions for issuing security gate entry request and exit request to an operating system, respectively.

25. The information processing apparatus according to claim 1, wherein the library function includes a basic library function and a service API library function.

26. The information processing apparatus according to claim 25, wherein the basic library function includes a shared memory operation system call instruction and a semaphore operation system call instruction as the privileged instructions, and
the service API library function includes a program code which uses the basic library function including the shared memory operation system call instruction and the semaphore operation system call instruction.

27. The information processing apparatus according to claim 25, wherein the basic library function includes a socket communication system call instruction as the privileged instruction in order to establish communication with an X server, and
the service API library function includes a program code which uses the basic library function including the socket communication system call instruction.

28. The information processing apparatus according to claim 25, wherein the basic library function includes a file open system call instruction as the privileged instruction in order to open a file that includes target content of DRM management, and
the service API library function performs DRM processing and includes a program code that uses the basic library function, which includes the file open system call instruction.

29. The information processing apparatus according to claim 25, wherein the basic library function includes a socket communication system call instruction as the privileged instruction in order to establish communication with an outside server, and
the service API library function performs HTTP processing and includes a program code that uses the basic library function, which includes the socket communication system call instruction.

30. An information processing method comprising:
retaining, in an information processing apparatus, the application process, an attribute value group thereof, an permissible address range of a first specific instruction, and a library function, in which the first specific instruction is executed before execution of a portion for guaranteeing execution of processing performed in the library function and a second specific instruction is executed before returning to a calling source of call;
performing a privileged instruction execution controlling process to control execution of a privileged instruction based on the attribute value group of the application process when internal interrupt is generated after the application process executes the privileged instruction;
performing a security gate entering process to check whether or not an address of the first specific instruction is within the permissible address range, when the internal interrupt is generated after the application process executes the first specific instruction, and changing the attribute value group of the application process when the address of the first specific instruction is within the permissible address range; and
performing a security gate exiting process to restore the attribute value group of the application process when the internal interrupt is generated after the application process executes the second specific instruction.

31. The information processing method according to claim 30, wherein the attribute value group indicates a security level of the application process.

32. The information processing method according to claim 31, wherein said performing a privileged instruction execution controlling process comprises:
performing an authority check based on the security level of the application process; and
executing the privileged instruction when authority to execute the privileged instruction is granted.

33. The information processing method according to claim 30, wherein the attribute value group indicates a security gate entry state of the application process.

34. The information processing method according to claim 33, wherein said performing a privileged instruction execution controlling process comprises:
executing the privileged instruction when the application process is in the security gate entry state.

35. The information processing method according to claim 30, wherein the attribute value group includes an attribute value indicates a security level of the application process and an attribute value indicating a security gate entry state of the application process.

36. The information processing method according to claim 35, wherein said performing a privileged instruction execution controlling process comprises:
executing a privileged instruction without authority check based on the security level of the application process when the application process is in a security gate entry state;
performing authority check based on the security level of the application process when the application process is not in the security gate entry state; and
executing the privileged instruction when the authority to execute a privileged instruction is granted.

37. The information processing method according to claim 35, wherein said performing a security gate entering process comprises:
changing a security level of the application process that is in a security gate entry state,
said performing a security gate exiting process comprises:
restoring a security level of the application process that is in the security gate exit state, and
said performing a privileged instruction execution controlling process comprises:
checking the authority check based on the security level of the application process; and
executing the privileged instruction when authority to execute the privileged instruction is granted.

38. The information processing method according to claim 35, wherein said performing a privileged instruction execution controlling process comprises:
performing authority check based on the security level of the application process after the security level of the application process is updated when the application process is in the security gate entry state; and
restoring the security level to an original level after the privileged instruction is executed when the authority to execute the privileged instruction is granted.

39. The information processing method according to claim 36, wherein the information processing apparatus restores the security level of the application process back to a level before the security gate entry state, before calling a signal/interrupt handler of the application process when a signal or interrupt is generated during running of the application process in the security gate entry state; and performs a security gate temporary exiting process in which the security level is restored to a level after the security gate entry state when or after processing by the signal/interrupt handler ends.

40. The information processing method according to claim 30, wherein the information processing apparatus restores the attribute value group of the application process to the attribute value group before change by the security gate entering process, before calling a signal/interrupt handler of the application process when a signal or interrupt is generated during running of the application process until the attribute value group of the application process is restored by the security gate exiting process after the attribute value group of the application process is changed by the security gate entering process; and performs a security gate temporary exiting process to restore the attribute value group to the attribute value group after the change by the security gate entering process when or after processing by the signal/interrupt handler is ends.

41. The information processing method according to claim 31, wherein said performing a security gate entering process comprises:
changing the security level of the application process to a privileged level.

42. The information processing method according to claim 31, wherein a computer comprises a security level change policy database to hold a security level changing rule, and
said performing a security gate entering process comprises:
changing the security level of the application process based on the security level changing rule.

43. The information processing method according to claim 33, wherein the attribute value group indicating the security gate entry state of the application process is recorded as one flag of a process management database to hold the security level corresponding to a process ID of each application process.

44. The information processing method according to claim 33, the information processing apparatus comprises a database for managing a list of application processes in a security gate entry state, and
the attribute value group indicating a security gate entry state of the application process is determined depending on whether or not a process ID is recorded in the database.

45. The information processing method according to claim 30, wherein the library function comprises the first specific instruction located before processing description for guaranteeing execution, and the second specific instruction is located before an exit returning to the calling source.

46. The information processing method according to claim 30, wherein the library function comprises the first specific instruction located before processing description for guaranteeing execution and an instruction sequence for changing a stack of the application process such that a function that includes the second specific instruction, is gone through on a path to be necessarily executed after a location where the first specific instruction is located, before returning to the calling source.

47. The information processing method according to claim 30, wherein the library function comprises the first specific instruction located before processing description for guaranteeing execution, and
said performing a security gate entering process comprises:
changing the stack of the application process such that the application process goes through a function that includes the second specific instruction, before returning to the calling source, when the attribute value group of the application process is changed.

48. A computer-readable record medium in which a program is stored for making a computer to perform an information processing method, wherein said computer comprises a computer-readable recording medium, which stores an application process, an attribute value group thereof, an permissible address range of a first specific instruction, and a library function, in which the first specific instruction is executed before execution of a portion for guaranteeing execution of processing performed in the library function and a second specific instruction is executed before returning to a calling source of call, said information processing method comprising:
performing a privileged instruction execution controlling process to control execution of a privileged instruction based on the attribute value group of the application process when internal interrupt is generated after the application process executes the privileged instruction;
performing a security gate entering process to check whether or not an address of the first specific instruction is within the permissible address range, when the internal interrupt is generated after the application process executes the first specific instruction, and changing the attribute value group of the application process when the address of the first specific instruction is within the permissible address range; and
performing a security gate exiting process to restore the attribute value group of the application process when the internal interrupt is generated after the application process executes the second specific instruction.

49. The computer-readable record medium according to claim 48, wherein the attribute value group indicates a security level of the application process.

50. The computer-readable record medium according to claim 49, wherein said performing a privileged instruction execution controlling process comprises:
performing an authority check based on the security level of the application process; and
executing the privileged instruction when authority to execute the privileged instruction is granted.

51. The computer-readable record medium according to claim 48, wherein the attribute value group indicates a security gate entry state of the application process.

52. The computer-readable record medium according to claim 51, wherein said performing a privileged instruction execution controlling process comprises:
executing the privileged instruction when the application process is in the security gate entry state.

53. The computer-readable record medium according to claim 48, wherein the attribute value group includes an attribute value indicates a security level of the application process and an attribute value indicating a security gate entry state of the application process.

54. The computer-readable record medium according to claim 53, wherein said performing a privileged instruction execution controlling process comprises:
executing a privileged instruction without authority check based on a security level of the application process when the application process is in a security gate entry state;
performing authority check based on the security level of the application process when the application process is not in the security gate entry state; and
executing the privileged instruction when the authority to execute a privileged instruction is granted.

55. The computer-readable record medium according to claim 53, wherein said performing a security gate entering process comprises:
changing a security level of the application process that is in a security gate entry state,
said performing a security gate exiting process comprises:
restoring a security level of the application process that is in the security gate exit state, and
said performing a privileged instruction execution controlling process comprises:
checking the authority check based on the security level of the application process; and
executing the privileged instruction when authority to execute the privileged instruction is granted.

56. The computer-readable record medium according to claim 53, wherein said performing a privileged instruction execution controlling process comprises:
performing authority check based on the security level of the application process after the security level of the application process is updated when the application process is in the security gate entry state; and
restoring the security level to an original level after the privileged instruction is executed when the authority to execute the privileged instruction is granted.

57. The computer-readable record medium according to claim 54, for making the computer to restore the security level of the application process back to a level before the security gate entry state, before calling a signal/interrupt handler of the application process when a signal or interrupt is generated during running of the application process in the security gate entry state; and to perform a security gate temporary exiting process in which the security level is restored to a level after the security gate entry state when or after processing by the signal/interrupt handler ends.

58. The computer-readable record medium according to claim 48, for making the information processing apparatus to restore the attribute value group of the application process to the attribute value group before change by the security gate entering process, before calling a signal/interrupt handler of the application process when a signal or interrupt is generated during running of the application process until the attribute value group of the application process is restored by the security gate exiting process after the attribute value group of the application process is changed by the security gate entering process; and to perform a security gate temporary exiting process to restore the attribute value group to the attribute value group after the change by the security gate entering process when or after processing by the signal/interrupt handler is ends.

59. The computer-readable record medium according to claim 49, wherein said performing a security gate entering process comprises:
changing the security level of the application process to a privileged level.

60. The computer-readable record medium according to claim 49, wherein a computer comprises a security level change policy database to hold a security level changing rule, and
said performing a security gate entering process comprises:
changing the security level of the application process based on the security level changing rule.

61. The computer-readable record medium according to claim 51, wherein the attribute value group indicating the security gate entry state of the application process is recorded as one flag of a process management database to hold the security level corresponding to a process ID of each application process.

62. The computer-readable record medium according to claim 51, the information processing apparatus comprises a database for managing a list of application processes in a security gate entry state, and
the attribute value group indicating a security gate entry state of the application process is determined depending on whether or not a process ID is recorded in the database.

63. The computer-readable record medium according to claim 48, wherein the library function comprises the first specific instruction located before processing description for guaranteeing execution, and the second specific instruction is located before an exit returning to the calling source.

64. The computer-readable record medium according to claim 48, wherein the library function comprises the first specific instruction located before processing description for guaranteeing execution and an instruction sequence for changing a stack of the application process such that a function that includes the second specific instruction, is gone through on a path to be necessarily executed after a location where the first specific instruction is located, before returning to the calling source.

65. The program computer-readable record medium according to claim 48, wherein the library function comprises the first specific instruction located before processing description for guaranteeing execution, and
said performing a security gate entering process comprises:
changing the stack of the application process such that the application process goes through a function that includes the second specific instruction, before returning to the calling source, when the attribute value group of the application process is changed.

66. The information processing apparatus according to claim 1, wherein the portion for guaranteeing execution of processing is a processing portion for guaranteeing safe execution of a critical process thereafter by carrying out a parameter check and a necessary pre-process.

67. The information processing method according to claim 30, wherein the portion for guaranteeing execution of processing is a processing portion for guaranteeing safe execution of a critical process thereafter by carrying out a parameter check and a necessary pre-process.

68. The computer-readable record medium according to claim 48, wherein the portion for guaranteeing execution of processing is a processing portion for guaranteeing safe execution of a critical process thereafter by carrying out a parameter check and a necessary pre-process.
